(19) United States
(12) Patent Application Publication
(10) Pub. No.: US 2026/0355833 A1
(43) Pub. Date: Nov. 12, 2026

(54) RECIPROCATING SAW

(71) Applicant: MAKITA CORPORATION, Anjo-shi, Aichi (JP)

(72) Inventors: Tomohiro UKAI, Anjo-shi (JP); Yuta YAMASHITA, Anjo-shi (JP)

(73) Assignee: MAKITA CORPORATION, Anjo-shi, Aichi (JP)

(21) Appl. No.: 19/120,886

(22) PCT Filed: Oct. 17, 2023
(86) PCT No.: PCT/JP2023/037577

§ 371 Date: Apr. 14, 2025

(30) Foreign Application Priority Data
Oct. 25, 2022 (JP) 2022-170810

(51) Int. Cl. B23D 49/16; B23D 51/02; B23D 51/04; B25B 1/20

(52) U.S. Cl. CPC B23D 49/162; B23D 51/02; B23D 51/04; B25B 1/205

(57) ABSTRACT

A reciprocating saw includes: a motor; a reciprocation conversion mechanism, which is disposed forward of the motor and reciprocates a blade based on a rotational force of the motor; a battery mounting portion to which a battery pack is mounted; and a vise mounting portion, which is dispose forward of the motor and to which a vise is mounted.

### TECHNICAL FIELD

Techniques disclosed in the present specification relate to a reciprocating saw.

### BACKGROUND ART

In the technical fields related to reciprocating saws, a saver saw to which a chain vise is attached as disclosed in Patent Document 1 is known.

### PRIOR ART LITERATURE

### Patent Documents

### Patent Document 1

Japanese Examined Utility Model (Registration) Application Publication No. H03-62722

### SUMMARY OF THE INVENTION

### Problems to Be Solved by the Invention

In a case where an AC power source is used as a power source of a reciprocating saw, a cord connecting the reciprocating saw and a plug-in wire connector (so-called outlet) is required. In addition, it may be difficult to secure the AC power supply in some work sites. In addition, in a case where work using the reciprocating saw is performed at a place away from the plug-in wire connector, it is necessary to use a long cord. In the case where the cord is long, a voltage drop may occur, work efficiency may be deteriorated, or work may not be able to be performed.

An object of the techniques disclosed in the present specification is to prevent a decrease in workability of a reciprocating saw to which a vise is attached.

### Means for Solving the Problems

The present specification discloses a reciprocating saw. The reciprocating saw may include: a motor; a reciprocation conversion mechanism, which is disposed forward of the motor and reciprocates a blade based on a rotational force of the motor; a battery mounting portion to which a battery pack is mounted; and a vise mounting portion, which is dispose forward of the motor and to which a vise is mounted.

### Effects of the Invention

According to the techniques disclosed in the present specification, decrease in workability of the reciprocating saw to which the vise is attached is prevented.

### BRIEF DESCRIPTION OF THE DRAWINGS

FIG. 1 is a front perspective view illustrating a reciprocating saw according to a first embodiment.

FIG. 2 is a rear perspective view illustrating the reciprocating saw of the first embodiment.

FIG. 3 is a diagram of the reciprocating saw of the first embodiment as viewed from above.

FIG. 4 is a diagram of the reciprocating saw of the first embodiment as viewed from the right side.

FIG. 5 is a cross-sectional view illustrating the reciprocating saw of the first embodiment.

FIG. 6 is an exploded view illustrating the reciprocating saw of the first embodiment.

FIG. 7 is a diagram illustrating the inside of the reciprocating saw of the first embodiment.

FIG. 8 is a diagram illustrating the inside of a reciprocating saw according to a modification of the first embodiment.

FIG. 9 is a diagram illustrating the inside of the reciprocating saw according to the modification of the first embodiment.

FIG. 10 is a diagram for describing a modification of a mounting method of a battery pack according to the first embodiment.

FIG. 11 is a diagram for describing the modification of the mounting method of the battery pack of the first embodiment.

FIG. 12 is a diagram for describing the modification of the mounting method of the battery pack of the first embodiment.

FIG. 13 is a diagram for describing the modification of the mounting method of the battery pack of the first embodiment.

FIG. 14 is a diagram for describing the modification of the mounting method of the battery pack of the first embodiment.

FIG. 15 is a diagram for describing the modification of the mounting method of the battery pack of the first embodiment.

FIG. 16 is a diagram for describing the modification of the mounting method of the battery pack of the first embodiment.

FIG. 17 is a diagram for describing the modification of the mounting method of the battery pack of the first embodiment.

FIG. 18 is a diagram for describing the modification of the mounting method of the battery pack of the first embodiment.

FIG. 19 is a diagram for describing the modification of the mounting method of the battery pack of the first embodiment.

FIG. 20 is a diagram for describing the modification of the mounting method of the battery pack of the first embodiment.

FIG. 21 is a diagram for describing the modification of the mounting method of the battery pack of the first embodiment.

FIG. 22 is a diagram for describing the modification of the mounting method of the battery pack of the first embodiment.

FIG. 23 is a diagram for describing the modification of the mounting method of the battery pack of the first embodiment.

FIG. 24 is a front perspective view illustrating a reciprocating saw according to a second embodiment.

FIG. 25 is a rear perspective view illustrating the reciprocating saw of the second embodiment.

FIG. 26 is a diagram of the reciprocating saw of the second embodiment as viewed from above.

FIG. 27 is a diagram of the reciprocating saw of the second embodiment as viewed from the right side.

FIG. 28 is an exploded view illustrating the reciprocating saw of the second embodiment.

FIG. 29 is a diagram illustrating the inside of the reciprocating saw of the second embodiment.

FIG. 30 is a diagram illustrating the inside of the reciprocating saw according to the modification of the second embodiment.

FIG. 31 is a diagram illustrating the inside of the reciprocating saw according to the modification of the second embodiment.

FIG. 32 is a diagram for describing a modification of a mounting method of a battery pack according to the second embodiment.

FIG. 33 is a diagram for describing the modification of the mounting method of the battery pack of the second embodiment.

FIG. 34 is a diagram for describing the modification of the mounting method of the battery pack of the second embodiment.

FIG. 35 is a diagram for describing the modification of the mounting method of the battery pack of the second embodiment.

FIG. 36 is a diagram for describing the modification of the mounting method of the battery pack of the second embodiment.

FIG. 37 is a diagram for describing the modification of the mounting method of the battery pack of the second embodiment.

FIG. 38 is a diagram for describing the modification of the mounting method of the battery pack of the second embodiment.

FIG. 39 is a diagram for describing the modification of the mounting method of the battery pack of the second embodiment.

FIG. 40 is a diagram of a reciprocating saw according to a third embodiment as viewed from the right side.

FIG. 41 is a cross-sectional view illustrating the reciprocating saw of the third embodiment.

FIG. 42 is a diagram of a rear portion of the reciprocating saw of the third embodiment as viewed from the right side.

FIG. 43 is an exploded perspective view of the rear portion of the reciprocating saw of the third embodiment as viewed from the rear side.

FIG. 44 is a diagram of a reciprocating saw according to a fourth embodiment as viewed from the right side.

FIG. 45 is a cross-sectional view illustrating the reciprocating saw of the fourth embodiment.

FIG. 46 is a diagram of a reciprocating saw according to a fifth embodiment as viewed from the right side.

FIG. 47 is a cross-sectional view illustrating the reciprocating saw of the fifth embodiment.

### MODES FOR CARRYING OUT THE INVENTION

In one or more embodiments, a reciprocating saw may include: a motor; a reciprocation conversion mechanism, which is disposed forward of the motor and reciprocates a blade based on a rotational force of the motor; a battery mounting portion to which a battery pack is mounted; and a vise mounting portion, which is disposed forward of the motor to which a vise is mounted.

In the above structure, since the battery pack that is a DC power supply is used as a power supply of the reciprocating saw, it is not necessary to connect a cord to the reciprocating saw. Therefore, decrease in workability of the reciprocating saw to which the vise is attached is prevented. In addition, since the power source of the reciprocating saw is the battery pack, it is not necessary to secure an AC power source at a work site. Therefore, an operator can perform work using the reciprocating saw without being restricted by the working environment.

In one or more embodiments, the reciprocating saw may include a grip portion. The motor and the battery mounting portion may be each disposed forward of the grip portion.

In the above structure, since the battery pack as a heavy object is disposed forward of the grip portion, a load applied to the operator can be reduced in cutting work using the vise.

In one or more embodiments, the battery mounting portion may be disposed rearward of the motor.

In the above structure, since the weight balance of the reciprocating saw is improved, a load on the operator can be reduced in cutting work using the vise.

In one or more embodiments, the battery mounting portion may be disposed downward of the motor.

In the above structure, since the weight balance of the reciprocating saw is improved, a load on the operator can be reduced in cutting work using the vise.

In one or more embodiments, the vise may be mounted to the vise mounting portion by being inserted from one side toward other side of the vise mounting portion in a left-right direction, and the battery pack may be mounted to the battery mounting portion by being inserted from one side toward other side of the battery mounting portion in the left-right direction.

In the above structure, for example, in a case where the vise is mounted to the vise mounting portion by being inserted from the left side toward the right side of the vise mounting portion and the battery pack is mounted to the battery mounting portion by being inserted from the left side toward the right side of the battery mounting portion, the vise is disposed on the left side of the reciprocating saw, and the battery pack protrudes to the left side of the reciprocating saw. Therefore, in cutting work using the vise, deterioration of workability is prevented.

In one or more embodiments, the reciprocating saw may include a grip portion. The motor may be disposed forward of the grip portion, and the battery mounting portion may be disposed rearward of the grip portion.

In the above structure, since the battery pack as a heavy object is disposed rearward of the grip portion, the weight balance of the reciprocating saw is improved.

In one or more embodiments, the battery mounting portion may be disposed at a rear end portion of the grip portion.

In the above structure, the weight balance of the reciprocating saw is improved.

In one or more embodiments, the battery pack may be mounted to the battery mounting portion by being inserted from one side toward other side of the battery mounting portion.

In the above structure, the operator can smoothly attach and detach the battery pack to and from the battery mounting portion.

In one or more embodiments, the battery pack may be mounted to the battery mounting portion by being inserted from un upper side toward a lower side of the battery mounting portion.

In the above structure, the operator can smoothly attach and detach the battery pack to and from the battery mounting portion.

In one or more embodiments, the reciprocating saw may include a controller that controls the motor. The controller may be disposed rearward of the motor.

In one or more embodiments, the reciprocating saw may include a grip portion. The motor, the battery mounting portion, and the controller may be each disposed forward of the grip portion.

In the above structure, since the battery pack as a heavy object, the motor, and the controller are each disposed forward of the grip portion, it is possible to reduce the load applied to the operator in the cutting work using the vise.

In one or more embodiments, the reciprocating saw may include a grip portion. The motor and the battery mounting portion may be each disposed forward of the grip portion, and the controller may be disposed rearward of the grip portion.

In one or more embodiments, the reciprocating saw may include a grip portion. The motor and the controller may be each disposed forward of the grip portion, and the battery mounting portion may be disposed rearward of the grip portion.

In the above structure, the weight balance of the reciprocating saw is improved.

In one or more embodiments, the reciprocating saw may include a grip portion. The motor may be disposed forward of the grip portion, and the battery mounting portion and the controller may be each disposed rearward of the grip portion.

Hereinafter, embodiments will be described with reference to the drawings. In the embodiments, positional relationships among the parts will be described using the terms left, right, front, rear, up, and down. These terms indicate relative position or direction, wherein the center of a reciprocating saw is the reference. The reciprocating saw has a motor 8 as a power source.

In the embodiments, a direction parallel to a rotation axis AX of the motor 8 is referred to as an axial direction as appropriate, a direction around the rotation axis AX is referred to as a circumferential direction or a rotation direction as appropriate, and a radiation direction of the rotation axis AX is referred to as a radial direction as appropriate.

In the embodiments, the rotation axis AX extends in the front-rear direction. The axial direction parallel to the rotation axis AX is the front-rear direction. In addition, in the radial direction, a position close to or a direction approaching the rotation axis AX is referred to as a radially inner side as appropriate, and a position far from or a direction away from the rotation axis AX is referred to as a radially outer side as appropriate.

### First Embodiment

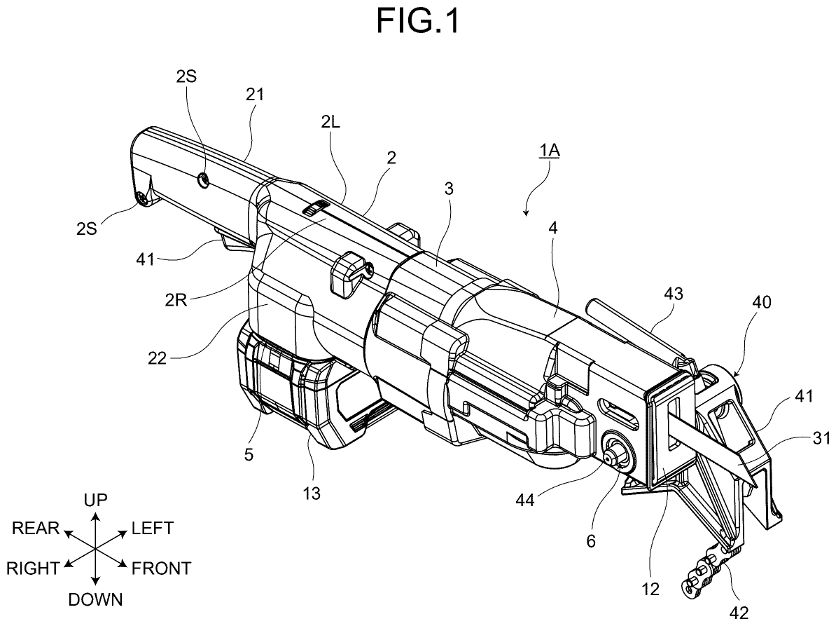

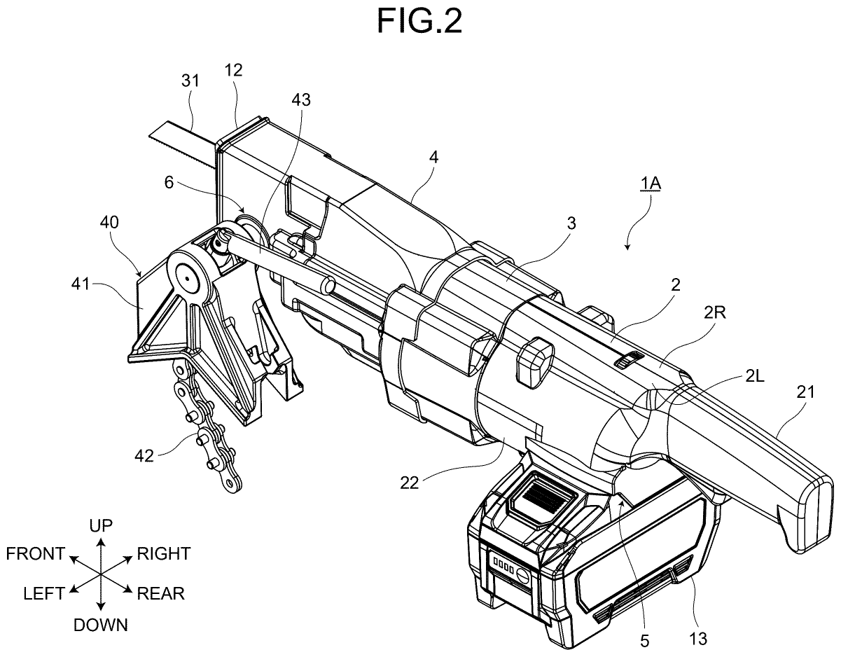

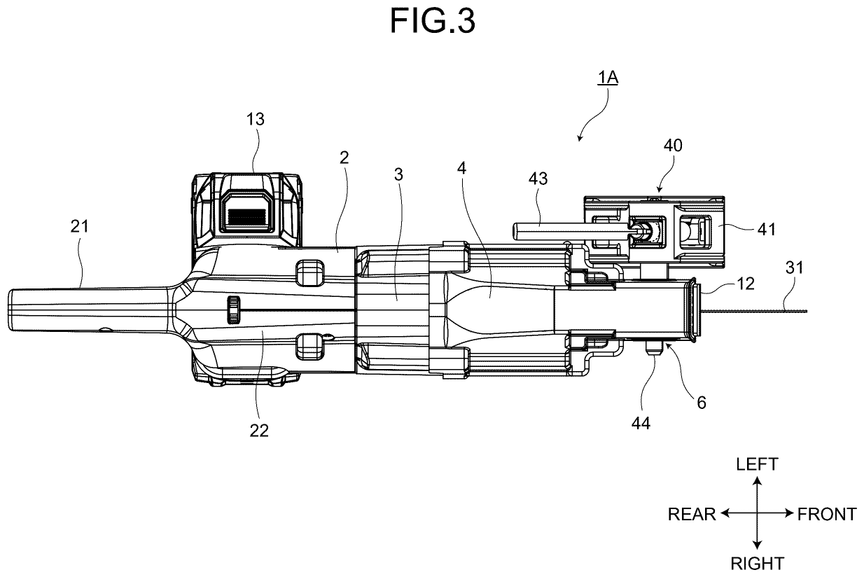

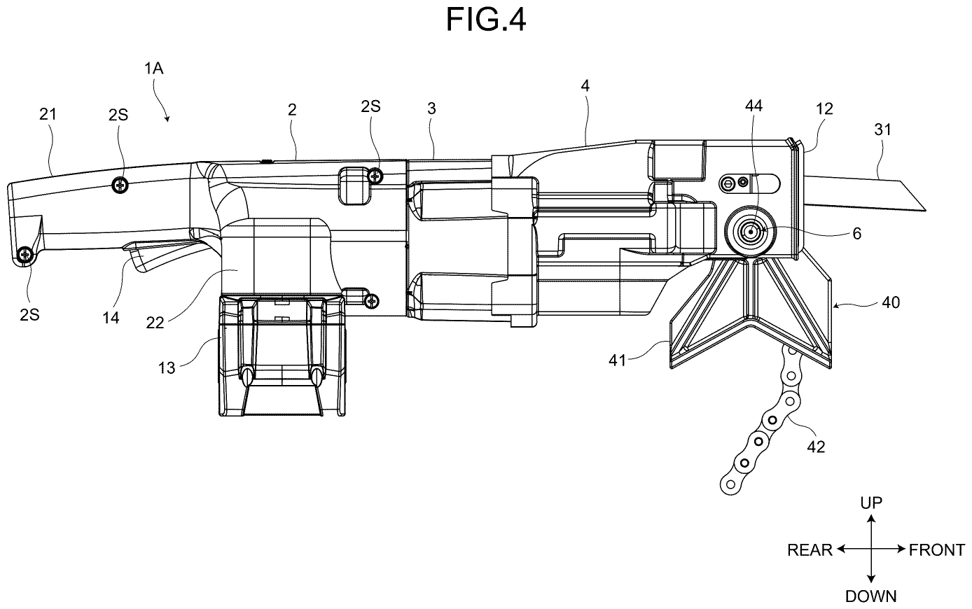

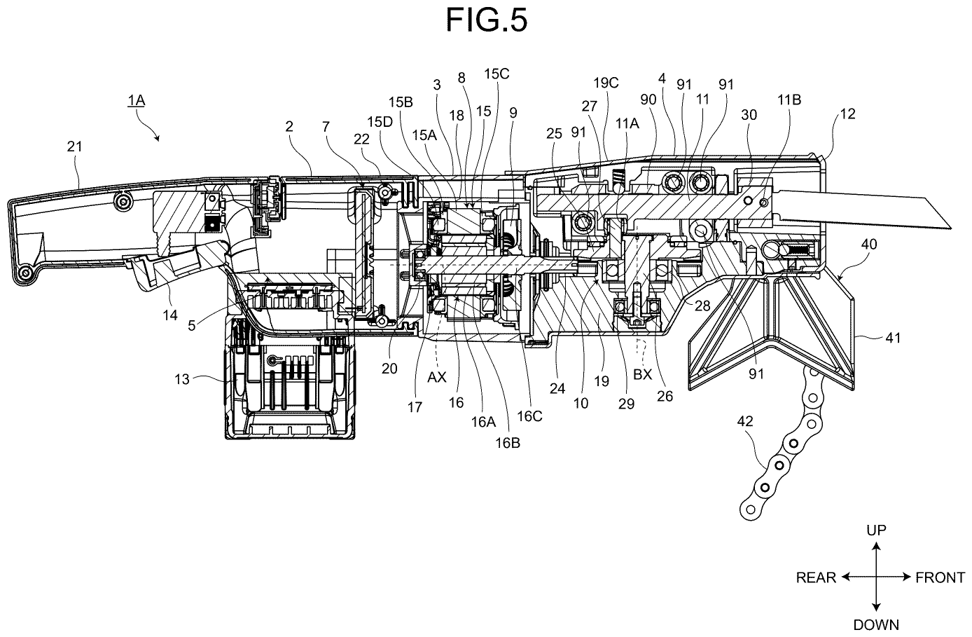

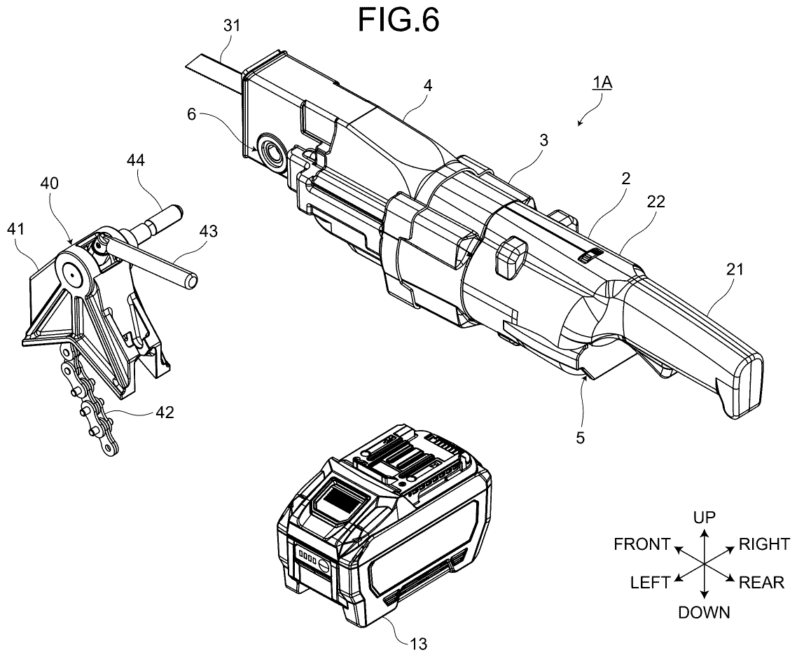

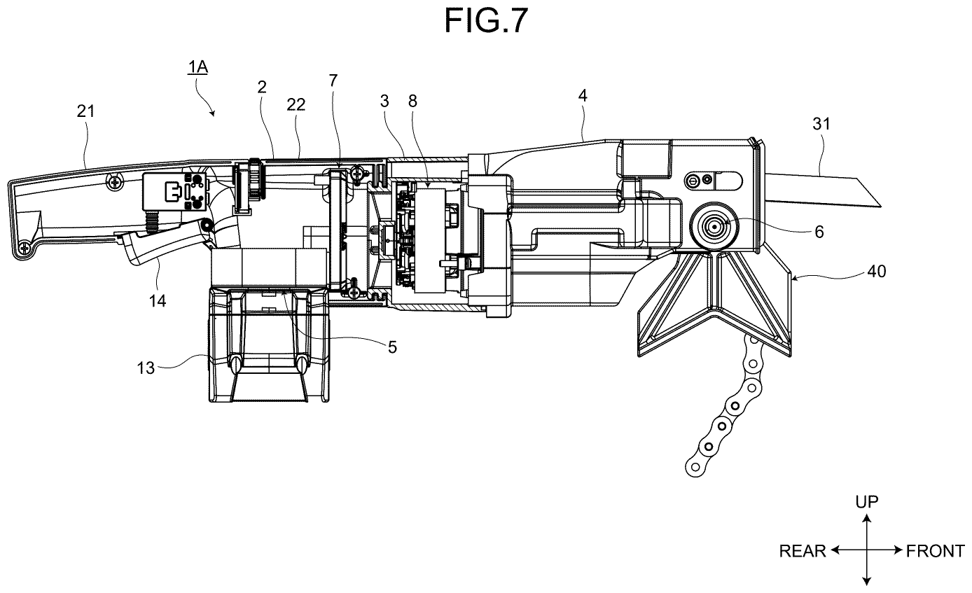

FIG. 1 is a front perspective view illustrating a reciprocating saw 1A according to the present embodiment. FIG. 2 is a rear perspective view illustrating the reciprocating saw 1A of the embodiment. FIG. 3 is a diagram of the reciprocating saw 1A of the embodiment as viewed from above. FIG. 4 is a diagram of the reciprocating saw 1A of the present embodiment as viewed from the right side. FIG. 5 is a cross-sectional view illustrating the reciprocating saw 1A of the embodiment. FIG. 6 is an exploded view illustrating the reciprocating saw 1A of the embodiment. FIG. 7 is a diagram illustrating the inside of the reciprocating saw 1A of the embodiment.

The reciprocating saw 1A includes a rear housing 2, a middle housing 3, a front housing 4, a battery mounting portion 5, a vise mounting portion 6, a controller 7, a motor 8, a fan 9, a reciprocation conversion mechanism 10, a slider 11, and a guide shoe 12.

The rear housing 2 is made of synthetic resin. The rear housing 2 includes a left housing 2L and a right housing 2R disposed on the right side of the left housing 2L. The left housing 2L and the right housing 2R constitute a pair of half-split housings. The rear housing 2 is constituted by a pair of half-split housings. The left housing 2L and the right housing 2R are fixed by a plurality of screws 2S.

The rear housing 2 includes a grip portion 21 and a controller housing portion 22. The grip portion 21 is gripped by an operator. The controller housing portion 22 houses the controller 7. The grip portion 21 has a rod shape elongated in the front-rear direction. The controller housing portion 22 is disposed on the front side of the grip portion 21.

A trigger lever 14 is disposed on the grip portion 21. The trigger lever 14 is operated by the operator to activate the motor 8. Driving and stopping of the motor 8 are switched by operating the trigger lever 14.

The middle housing 3 is disposed on the front side of the rear housing 2. The middle housing 3 has a tubular shape. The rear end portion of the middle housing 3 is fixed to the front end portion of the rear housing 2. The middle housing 3 houses the motor 8.

The front housing 4 is disposed on the front side of the middle housing 3. The front housing 4 has a tubular shape. The rear end portion of the front housing 4 is fixed to the front end of the middle housing 3. The front housing 4 houses the reciprocation conversion mechanism 10.

The battery mounting portion 5 is disposed below of the controller housing portion 22. A battery pack 13 is mounted to the battery mounting portion 5. The battery pack 13 functions as a DC power supply of the reciprocating saw 1A. The battery pack 13 is attachable to and detachable from the battery mounting portion 5. The battery pack 13 is mounted to the battery mounting portion 5 by being inserted into the battery mounting portion 5 from the left side toward the right side of the battery mounting portion 5. The battery pack 13 is removed from the battery mounting portion 5 by being removed leftward from the battery mounting portion 5. The battery pack 13 includes a secondary battery. In the present embodiment, the battery pack 13 includes a rechargeable lithium ion battery. By being mounted to the battery mounting portion 5, the battery pack 13 can supply power to the reciprocating saw 1A. The motor 8 is driven based on electric power supplied from the battery pack 13.

The controller 7 controls at least the motor 8. The controller 7 includes a circuit board and a plurality of electronic components mounted on the circuit board. Examples of the electronic components include a microcomputer and a switching element. The controller 7 is housed in the rear housing 2.

The motor 8 is a power source of the reciprocating saw 1A. The motor 8 is an electric motor. The motor 8 is an inner-rotor-type brushless motor. The motor 8 includes a stator 15 and a rotor 16. The stator 15 is disposed around the rotor 16. The rotor 16 rotates with respect to the stator 15. The rotor 16 rotates about a rotation axis AX. The rotation axis AX extends in the front-rear direction.

The stator 15 includes a cylindrical stator core 15A, a rear insulator 15B fixed to a rear portion of the stator core 15A, a front insulator 15C fixed to a front portion of the stator core 15A, and a plurality of coils 15D wound around teeth of the stator core 15A via the rear insulator 15B and the front insulator 15C.

The rotor 16 includes a rotor core 16A, a permanent magnet 16B, and a rotor shaft 16C. A sensor substrate 17, which detects rotation of the rotor 16 by detecting the position of the permanent magnet 16B, is mounted to the rear insulator 15B.

At least a part of the motor 8 is housed in a motor case 18. The middle housing 3 includes the motor case 18. A gear case 19 is disposed forward of the motor case 18. The front housing 4 includes the gear case 19 and a cover 19C that covers the gear case 19. The cover 19C is made of rubber and has an insulating property. The reciprocation conversion mechanism 10 is housed in the gear case 19.

The stator 15 is disposed inside the motor case 18. The stator 15 is fixed to the motor case 18.

The rear end portion of the rotor shaft 16C is rotatably supported by a rotor bearing 20. The rotor bearing 20 is held by the motor case 18.

The fan 9 is fixed to a front portion of the rotor shaft 16C. When the rotor shaft 16C rotates, the fan 9 rotates. with the fan 9 rotating, an air flow is generated around the motor 8. The motor 8 is cooled by the airflow generated by the rotation of the fan 9.

A pinion gear 24 is provided at the front end portion of the rotor shaft 16C. The pinion gear 24 is disposed inside the gear case 19. The rotor shaft 16C is coupled to the reciprocation conversion mechanism 10 via the pinion gear 24.

The reciprocation conversion mechanism 10 converts the rotational motion of the rotor 16 into reciprocating motion in the front-rear direction. The reciprocation conversion mechanism 10 is disposed forward of the motor 8. The reciprocation conversion mechanism 10 reciprocates a blade 31 held by the slider 11 in the front-rear direction based on the rotational force of the motor 8. The slider 11 holds the blade 31 via a blade holder 30.

The reciprocation conversion mechanism 10 includes a bevel gear 25 to which the pinion gear 24 is coupled, a support shaft 26 to which the bevel gear 25 is fixed, and an eccentric pin 27 provided at an eccentric position of the bevel gear 25. The support shaft 26 is rotatably supported by a bearing 28 and a bearing 29. A slider block 11A is provided to the slider 11. At least a part of the eccentric pin 27 is disposed inside the slider block 11A. The bevel gear 25 rotates about a rotation axis BX orthogonal to the rotation axis AX. With the bevel gear 25 rotating and the eccentric pin 27 turning around the rotation axis BX, the eccentric pin 27 moves in the left-right direction inside the slider block 11A. With the eccentric pin 27 moving in the left-right direction inside the slider block 11A while turning around the rotation axis BX, the slider 11 reciprocates in the front-rear direction.

The slider 11 reciprocates in the front-rear direction by the rotational force of the motor 8 transmitted via the reciprocation conversion mechanism 10. The slider 11 is guided in the front-rear direction by a slider guide 90 and a slider guide 91. The slider 11 has a holder portion 11B that holds the blade 31, which is a type of tip tools. The holder portion 11B is provided at the front end portion of the slider 11. The slider 11 functions as a tip tool holder to which the tip tool is attached. The guide shoe 12 is provided on the front side of the slider 11.

A vise 40 is mounted to the vise mounting portion 6. The vise 40 is fixed to a target to be cut. The vise 40 includes a fixing member 41 to be brought into contact with a target to be cut, a winding member 42 connected to the fixing member 41 and wound around the target to be cut, a fastener 43 that is operated to fasten the winding member 42, and a mounting member 44 to be mounted to the vise mounting portion 6.

The vise mounting portion 6 is disposed forward of the motor 8. The vise mounting portion 6 is disposed forward of the reciprocation conversion mechanism 10. The vise mounting portion 6 includes a hole provided at the front end portion of the front housing 4. The mounting member 44 includes a rod-shaped member to be inserted into a hole of the vise mounting portion 6. In the present embodiment, the winding member 42 is a chain. In the present embodiment, the vise 40 is a so-called chain vise.

The vise 40 is attachable to and detachable from the vise mounting portion 6. With the mounting member 44 inserted into the vise mounting portion 6 from the left side toward the right side of the vise mounting portion 6, the vise 40 is mounted on the vise mounting portion 6. With the mounting member 44 removed leftward from the vise mounting portion 6, the vise 40 is removed from the vise mounting portion 6.

In a case where, for example, a pipe serving as a target to be cut is cut, an operator brings the fixing member 41 into contact with a part of the pipe and winds the winding member 42 around the pipe. After the winding member 42 is wound around the pipe, the operator operates the fastener 43 to fasten the winding member 42 to the pipe. Accordingly, the vise 40 is fixed to the pipe. After the vise 40 is fixed to the pipe, the operator operates the trigger lever 14. When the trigger lever 14 is operated, the motor 8 is driven by the electric power supplied from the battery pack 13. When the rotor 16 rotates about the rotation axis AX, the pinion gear 24 provided at the front end portion of the rotor shaft 16C rotates. When the pinion gear 24 rotates, the bevel gear 25 coupled to the pinion gear 24 rotates. When the bevel gear 25 rotates, the eccentric pin 27 eccentrically moves with respect to the rotation axis BX of the bevel gear 25, and the slider 11 reciprocates in the front-rear direction. When the slider 11 reciprocates in the front-rear direction, the blade 31 mounted on the slider 11 reciprocates in the front-rear direction. In a state where the blade 31 reciprocates in the front-rear direction, the operator grips the grip portion 21 and rotates the reciprocating saw 1A around the mounting member 44. The operator rotates the reciprocating saw 1A around the mounting member 44 while gripping the grip portion 21 such that the grip portion 21 moves upward and that the blade 31 moves downward. As a result, the reciprocating blade 31 is pushed into the pipe, and the pipe is cut.

In the present embodiment, the motor 8 and the battery mounting portion 5 are each disposed forward of the grip portion 21. The battery mounting portion 5 is disposed rearward of the motor 8. The battery mounting portion 5 is disposed downward of the motor 8.

The controller 7 is disposed rearward of the motor 8. The motor 8, the battery mounting portion 5, and the controller 7 are each disposed forward of the grip portion 21. In the present embodiment, the controller 7 has a plate shape. The controller 7 is disposed such that a surface of the controller 7 is orthogonal to the rotation axis AX.

As described above, in the present embodiment, the reciprocating saw 1A includes: the motor 8; the reciprocation conversion mechanism 10, which is disposed on the front side of the motor 8 and reciprocates the blade 31 on the basis of the rotational force of the motor 8; the battery mounting portion 5 to which the battery pack 13 is mounted; and the vise mounting portion 6, which is disposed forward of the motor 8 to which the vise 40 is mounted.

In the above structure, since the battery pack 13 that is a DC power supply is used as the power supply of the reciprocating saw 1A, it is not necessary to connect a cord to the reciprocating saw 1A. Therefore, decrease in workability of the reciprocating saw 1A to which the vise 40 is attached is prevented. In addition, since the power source of the reciprocating saw 1A is the battery pack 13, it is not necessary to secure an AC power source at a work site. Therefore, an operator can perform work using the reciprocating saw 1A without being restricted by the working environment.

In the present embodiment, the reciprocating saw 1A includes the grip portion 21. The motor 8 and the battery mounting portion 5 are each disposed on the front side of the grip portion 21.

In the above structure, since the battery pack 13 as a heavy object is disposed forward of the grip portion 21, a load applied to the operator can be reduced in cutting work using the vise 40. As described above, for example, in the case of cutting the pipe, the operator rotates the reciprocating saw 1A around the mounting member 44 while gripping the grip portion 21 such that the grip portion 21 moves upward and that the blade 31 moves downward. Since the battery pack 13 as a heavy object is disposed forward of the grip portion 21, a load applied to the operator can be reduced in cutting work using the vise 40.

In the present embodiment, the battery mounting portion 5 is disposed rearward of the motor 8.

In the above structure, since the weight balance of the reciprocating saw 1A is improved, the load on the operator can be reduced in the cutting work using the vise 40.

In the present embodiment, the battery mounting portion 5 is disposed downward of the motor 8.

In the above structure, since the weight balance of the reciprocating saw 1A is improved, the load on the operator can be reduced in the cutting work using the vise 40.

In the present embodiment, the vise 40 is mounted to the vise mounting portion 6 by being inserted from one side toward other side of the vise mounting portion 6 in the left-right direction, and the battery pack 13 is mounted to the battery mounting portion 5 by being inserted from one side toward other side of the battery mounting portion 5 in the left-right direction.

In the present embodiment, the reciprocating saw 1A includes the controller 7 that controls the motor 8. The controller 7 is disposed rearward of the motor 8.

In the present embodiment, the motor 8, the battery mounting portion 5, and the controller are each disposed forward of the grip portion 21.

In the above structure, since the battery pack 13 as a heavy object, the motor 8, and the controller are each disposed forward of the grip portion 21, it is possible to reduce the load applied to the operator in the cutting work using the vise 40.

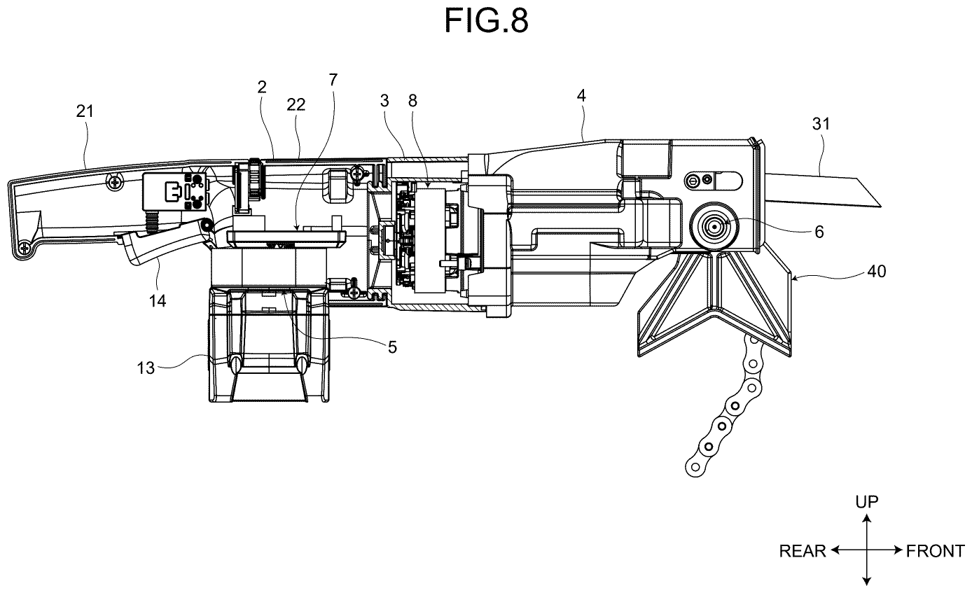

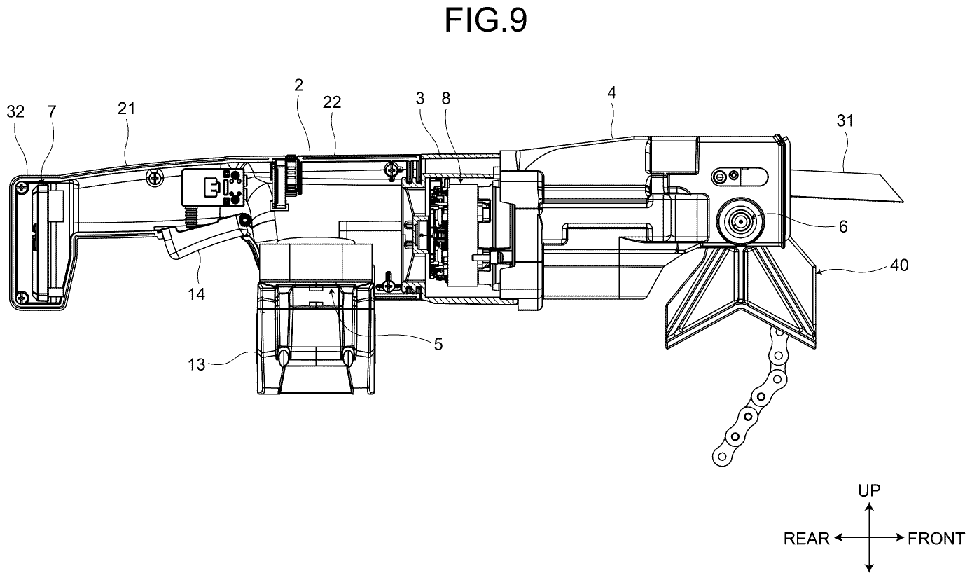

Hereinafter, modifications of the present embodiment will be described. Each of FIGS. 8 and 9 is a diagram illustrating the inside of a reciprocating saw 1A according to a modification of the embodiment. As illustrated in FIG. 8, the controller 7 may be disposed such that a surface of the controller 7 is parallel to a rotation axis AX.

As illustrated in FIG. 9, the motor 8 and the battery mounting portion 5 may be each disposed forward of a grip portion 21, and the controller 7 may be disposed rearward of the grip portion 21. In the example illustrated in FIG. 9, the controller housing portion 32 is provided at the rear end portion of the grip portion 21. The controller 7 is housed in the controller housing portion 32.

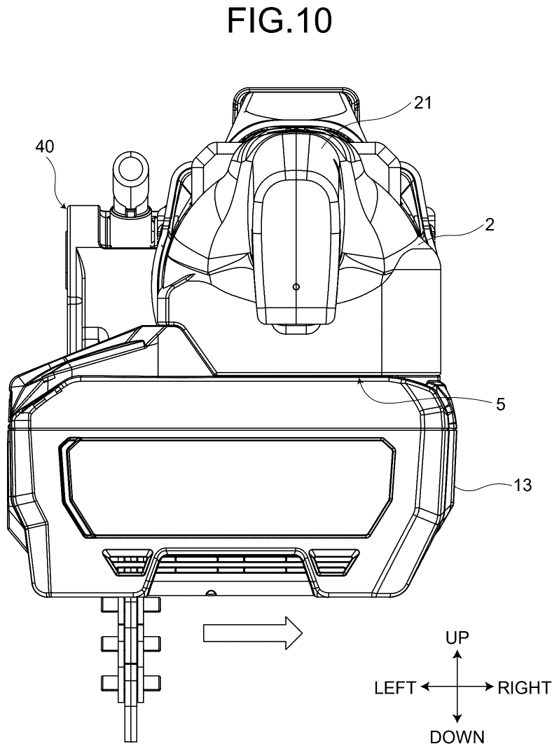

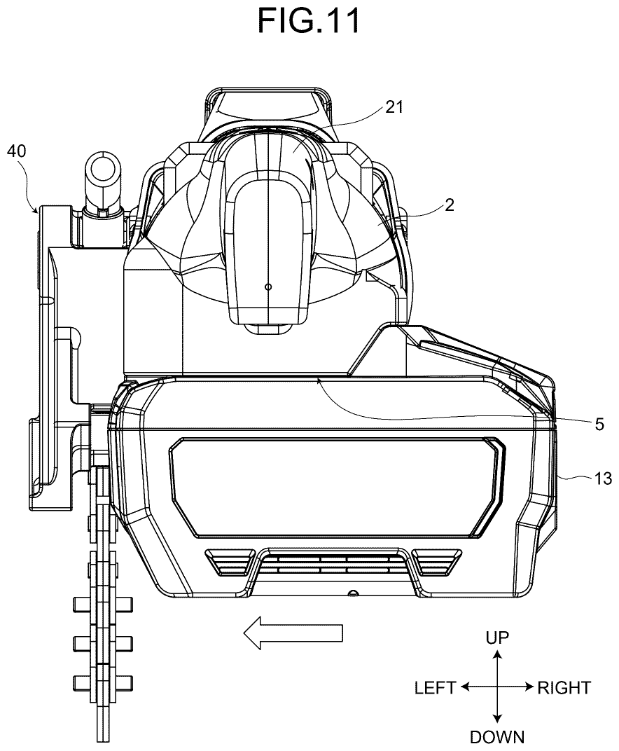

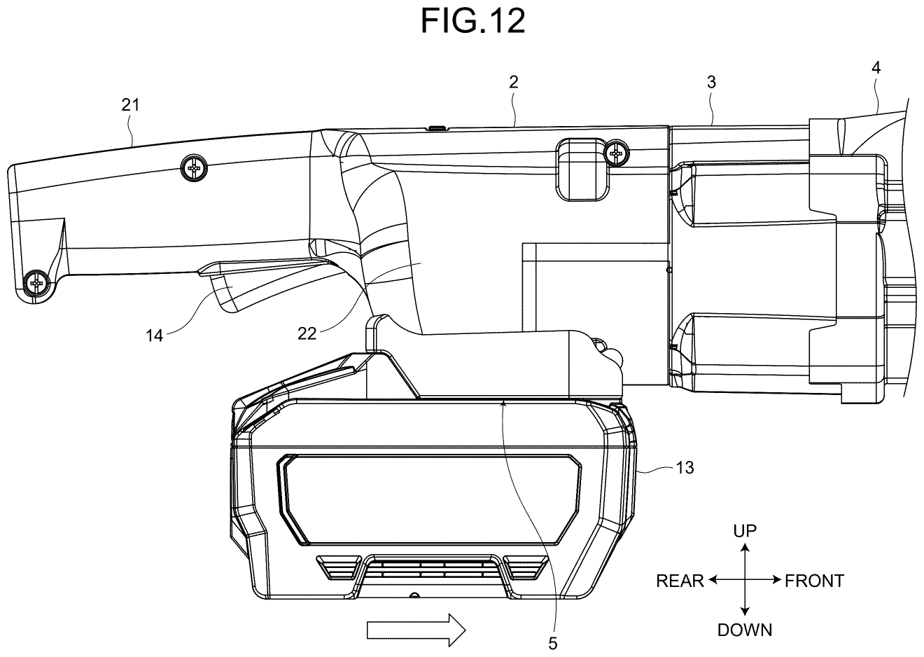

Each of FIGS. 10, 11, and 12 is a diagram for describing a modification of the mounting method of the battery pack 13 of the first embodiment. Each of FIGS. 10, 11, and 12 illustrates an example in which the battery mounting portion 5 is disposed downward of the motor 8. As illustrated in FIG. 10, the battery pack 13 may be mounted to the battery mounting portion 5 by being inserted from the left side toward the right side of the battery mounting portion 5. As illustrated in FIG. 11, the battery pack 13 may be mounted to the battery mounting portion 5 by being inserted from the right side toward the left side of the battery mounting portion 5. As illustrated in FIG. 12, the battery pack 13 may be mounted to the battery mounting portion 5 by being inserted from the rear side toward the front side of the battery mounting portion 5.

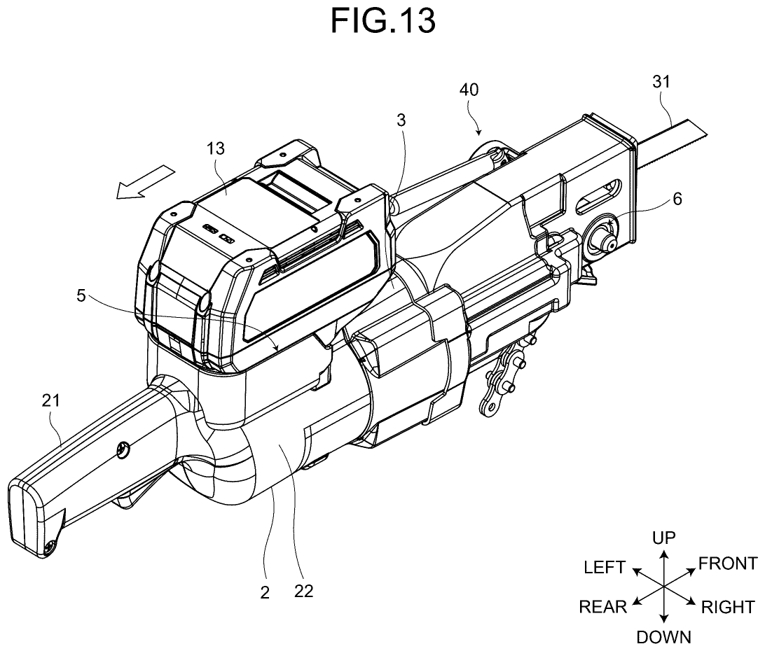

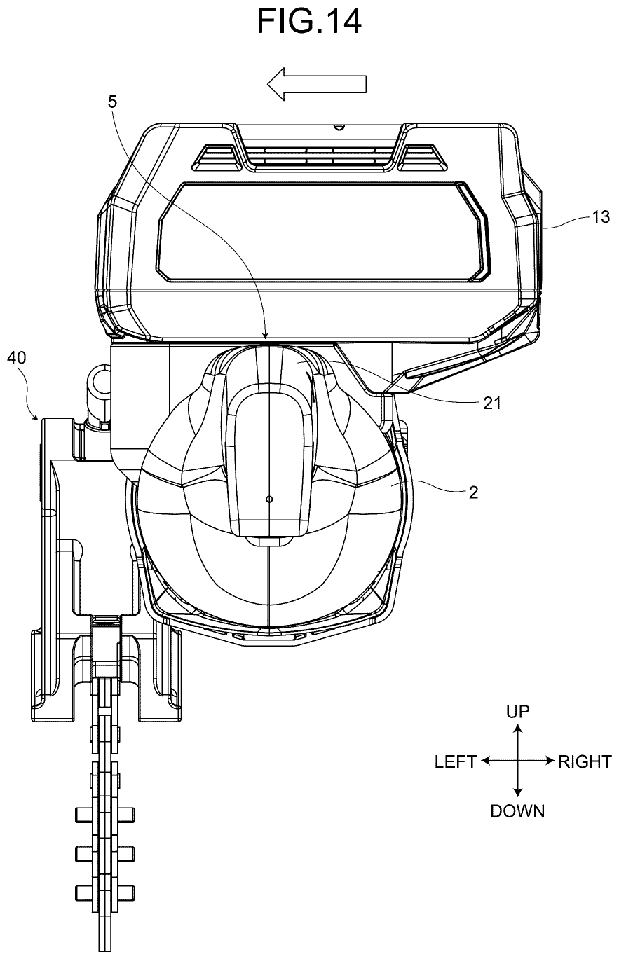

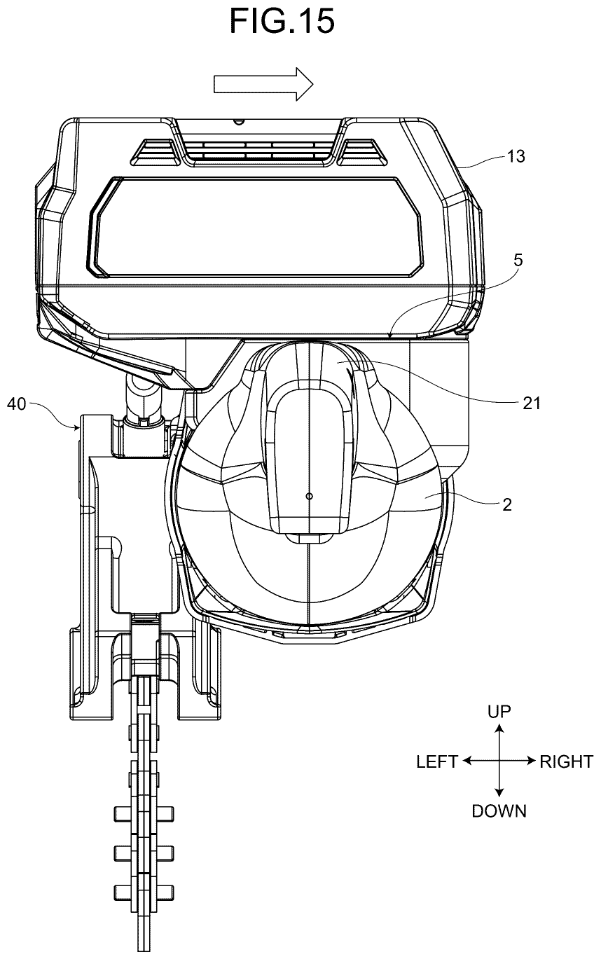

Each of FIGS. 13, 14, and 15 is a diagram for describing a modification of the mounting method of the battery pack 13 of the first embodiment. Each of FIGS. 13, 14, and 15 illustrates an example in which the battery mounting portion 5 is disposed upward of the motor 8. As illustrated in FIG. 13, the battery pack 13 may be mounted to the battery mounting portion 5 by being inserted from the front side toward the rear side of the battery mounting portion 5. As illustrated in FIG. 14, the battery pack 13 may be mounted to the battery mounting portion 5 by being inserted from the right side toward the left side of the battery mounting portion 5. As illustrated in FIG. 15, the battery pack 13 may be mounted to the battery mounting portion 5 by being inserted from the left side toward the right side of the battery mounting portion 5.

As described with reference to FIGS. 10 to 15, since the battery mounting portion 5 is disposed upward or downward the motor 8, the amount of protrusion of the battery pack 13 in the left-right direction of the reciprocating saw 1A is reduced. As a result, even in a case where there is an obstacle in the left-right direction of the reciprocating saw 1A in a cutting operation, the cutting operation is smoothly performed.

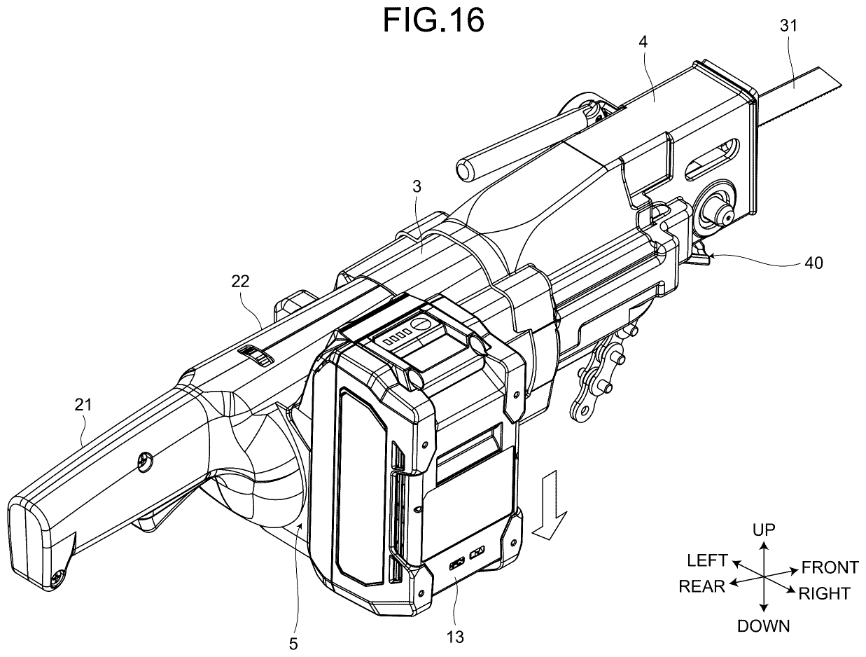

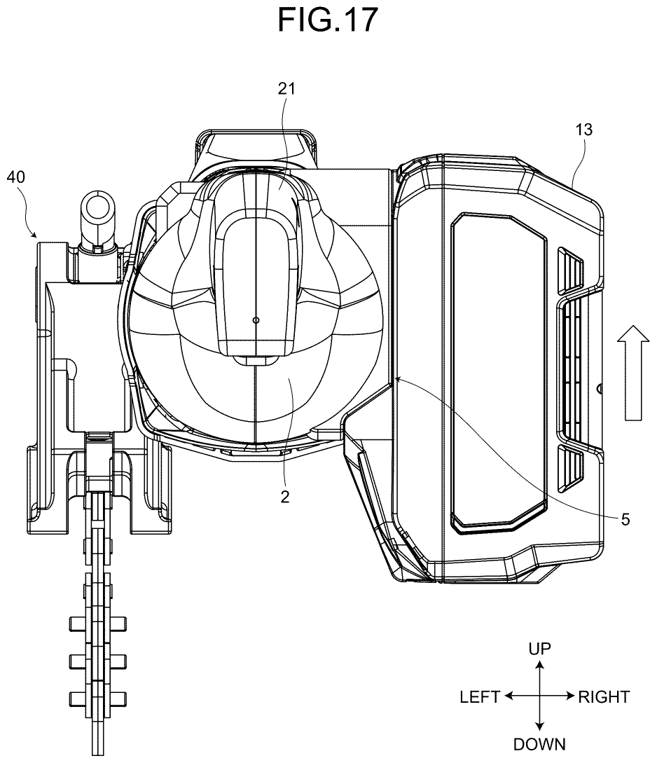

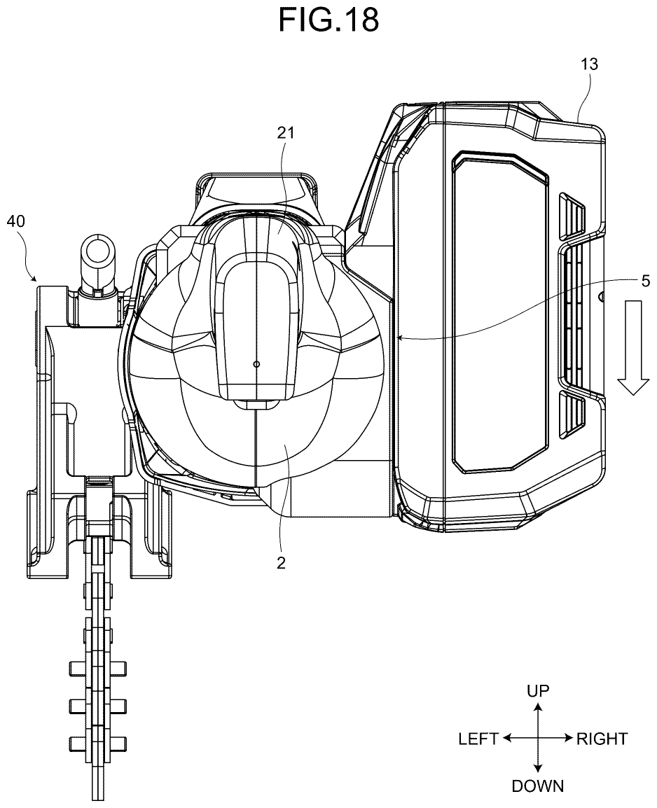

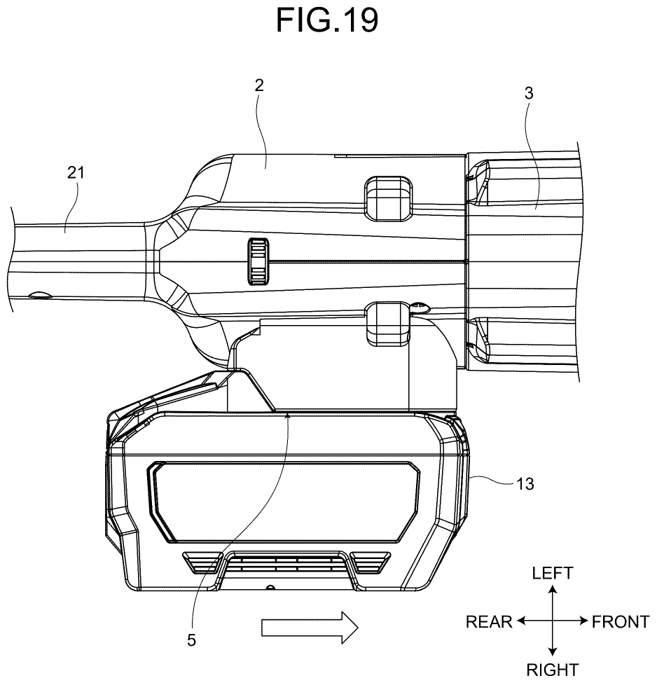

Each of FIGS. 16, 17, 18, and 19 is a diagram for describing a modification of the mounting method of the battery pack 13 of the first embodiment. Each of FIGS. 16, 17, 18, and 19 illustrates an example in which the battery mounting portion 5 is disposed on the right side of the motor 8. As illustrated in FIGS. 16 and 18, the battery pack 13 may be mounted to the battery mounting portion 5 by being inserted from the upper side toward the lower side of the battery mounting portion 5. As illustrated in FIG. 17, the battery pack 13 may be mounted to the battery mounting portion 5 by being inserted from the lower side toward the upper side of the battery mounting portion 5. As illustrated in FIG. 19, the battery pack 13 may be mounted to the battery mounting portion 5 by being inserted from the rear side toward the front side of the battery mounting portion 5.

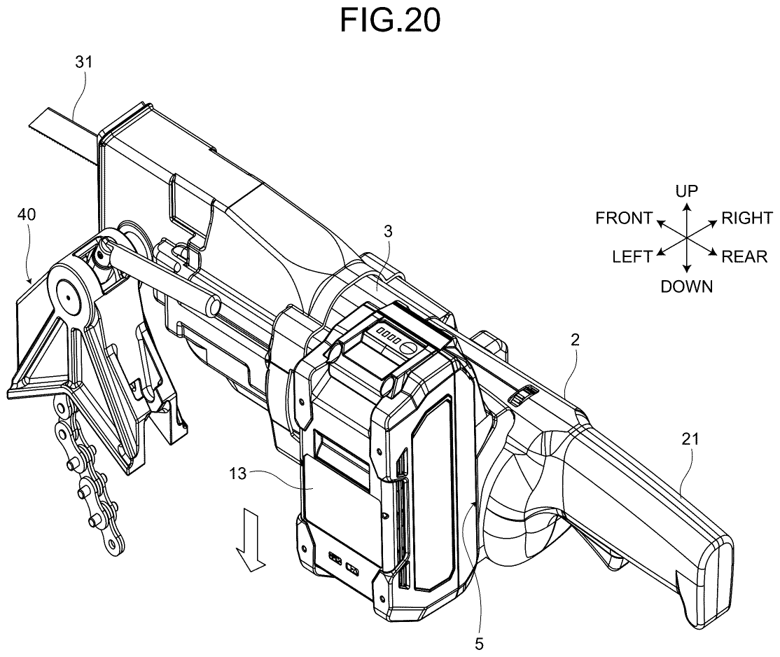

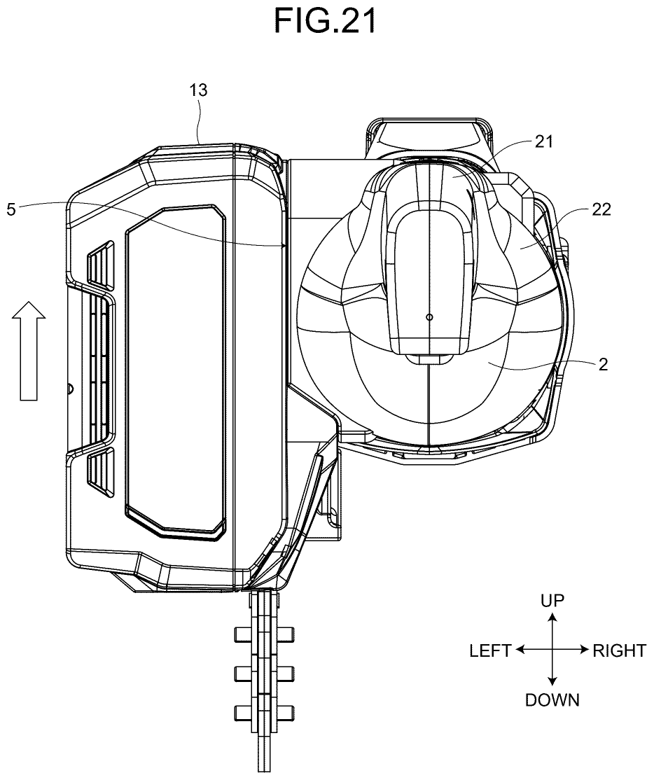

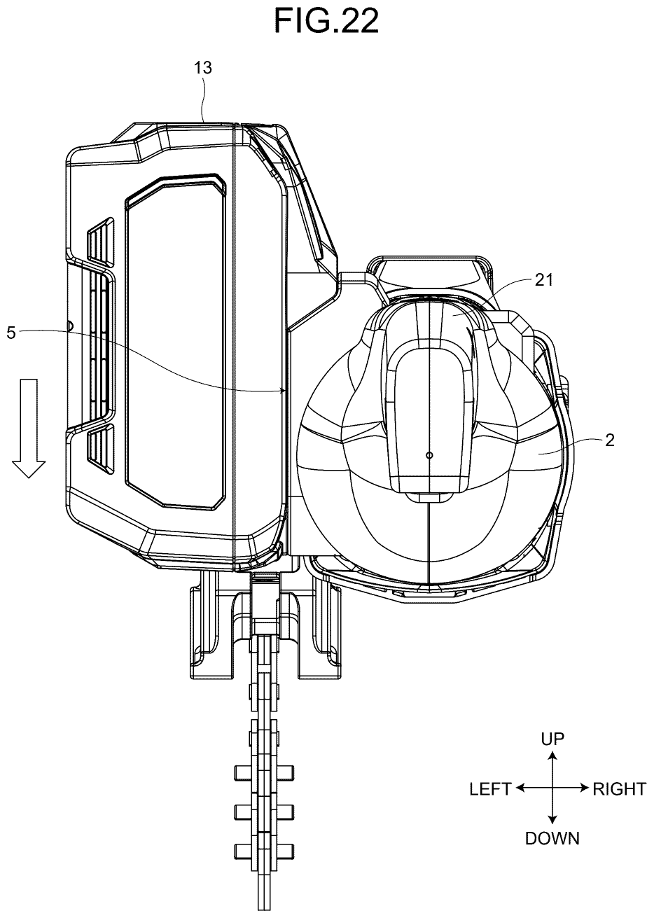

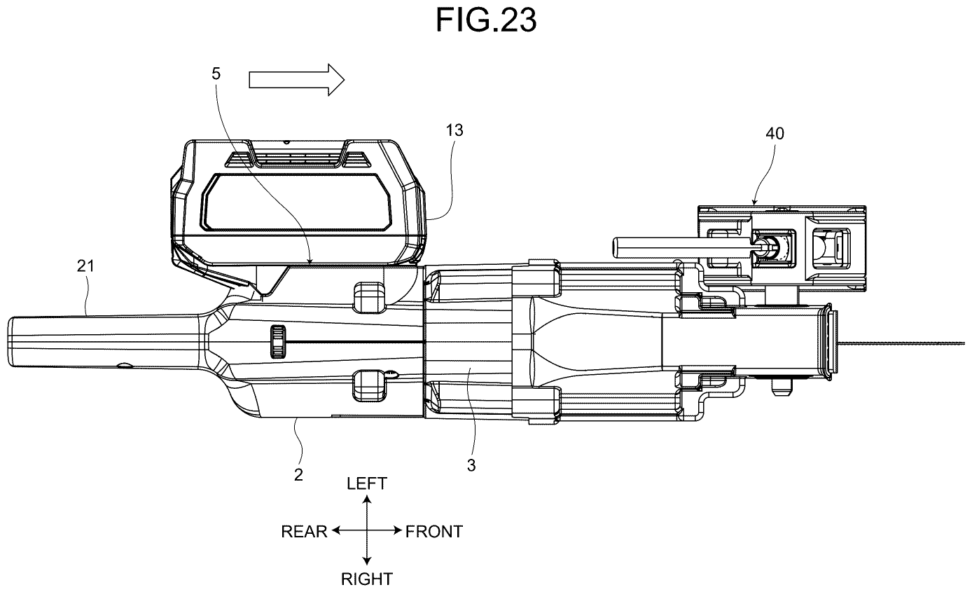

Each of FIGS. 20, 21, 22, and 23 is a diagram for describing a modification of the mounting method of the battery pack 13 of the first embodiment. Each of FIGS. 20, 21, 22, and 23 illustrates an example in which the battery mounting portion 5 is disposed on the left side of the motor 8. As illustrated in FIGS. 20 and 22, the battery pack 13 may be mounted to the battery mounting portion 5 by being inserted from the upper side toward the lower side of the battery mounting portion 5. As illustrated in FIG. 21, the battery pack 13 may be mounted to the battery mounting portion 5 by being inserted from the lower side toward the upper side of the battery mounting portion 5. As illustrated in FIG. 23, the battery pack 13 may be mounted to the battery mounting portion 5 by being inserted from the rear side toward the front side of the battery mounting portion 5.

As described with reference to FIGS. 16 to 23, since the battery mounting portion 5 is disposed on the left side or the right side of the motor 8, the amount of protrusion of the battery pack 13 in the up-down direction of the reciprocating saw 1A is reduced. As a result, even in a case where there is an obstacle in the up-down direction of the reciprocating saw 1A in a cutting operation, the cutting operation is smoothly performed.

### Second Embodiment

A second embodiment will be described. In the following description, the same or equivalent components as those of the above-described embodiment are denoted by the same reference numerals, and description of the components is simplified or omitted.

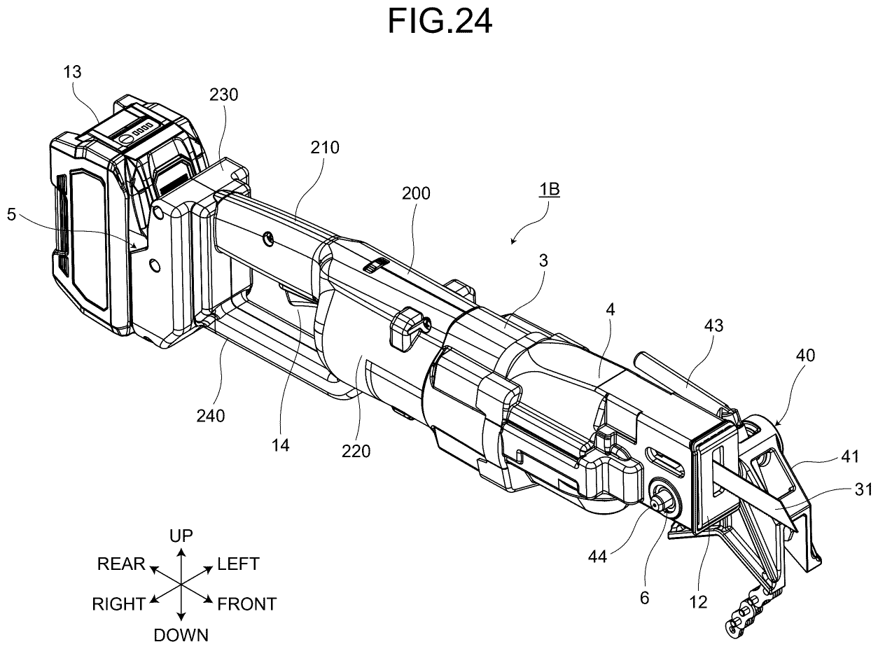

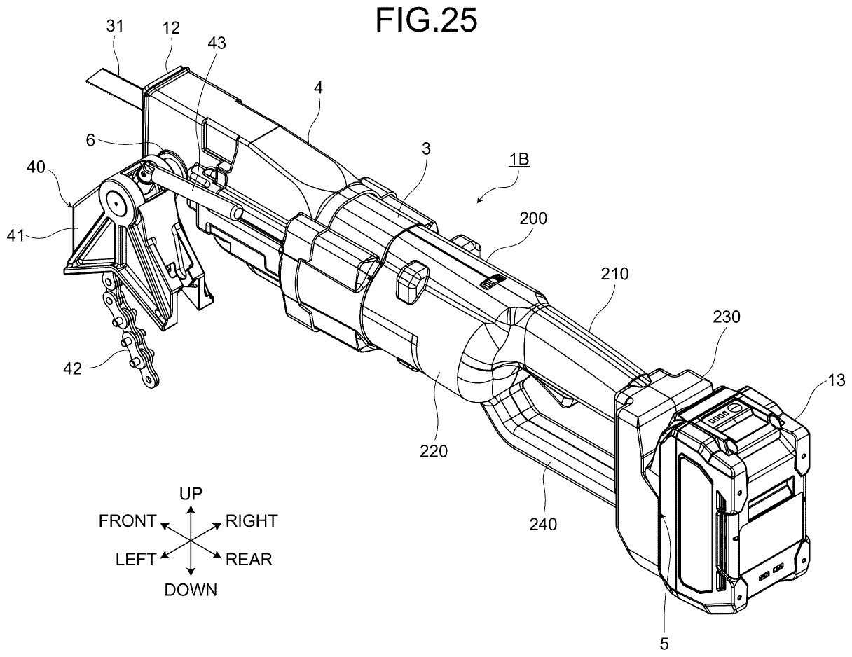

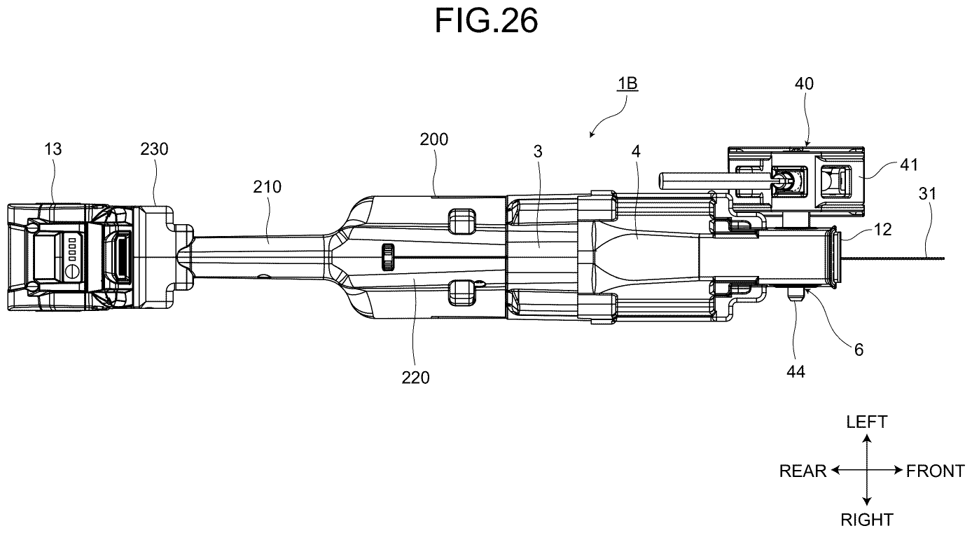

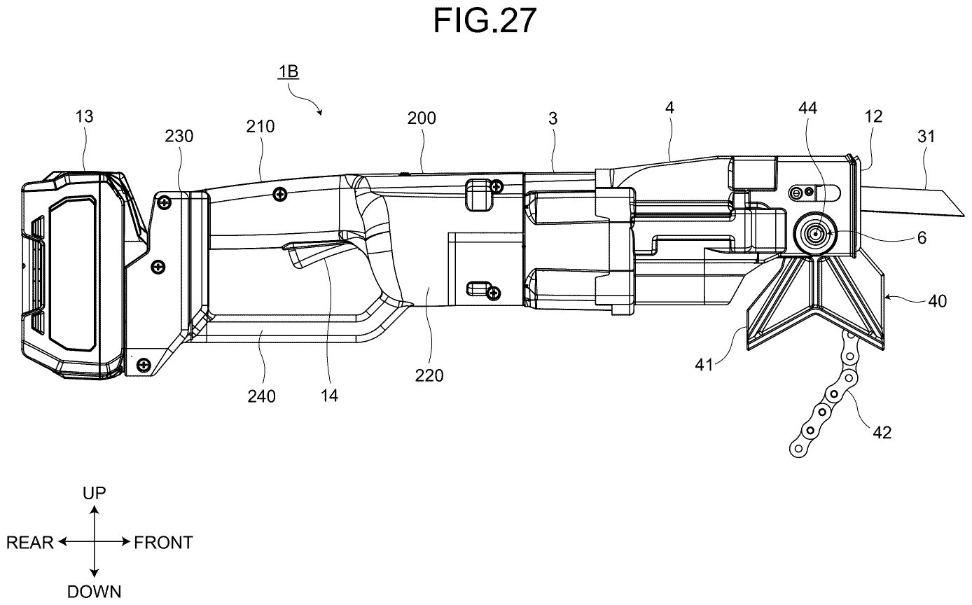

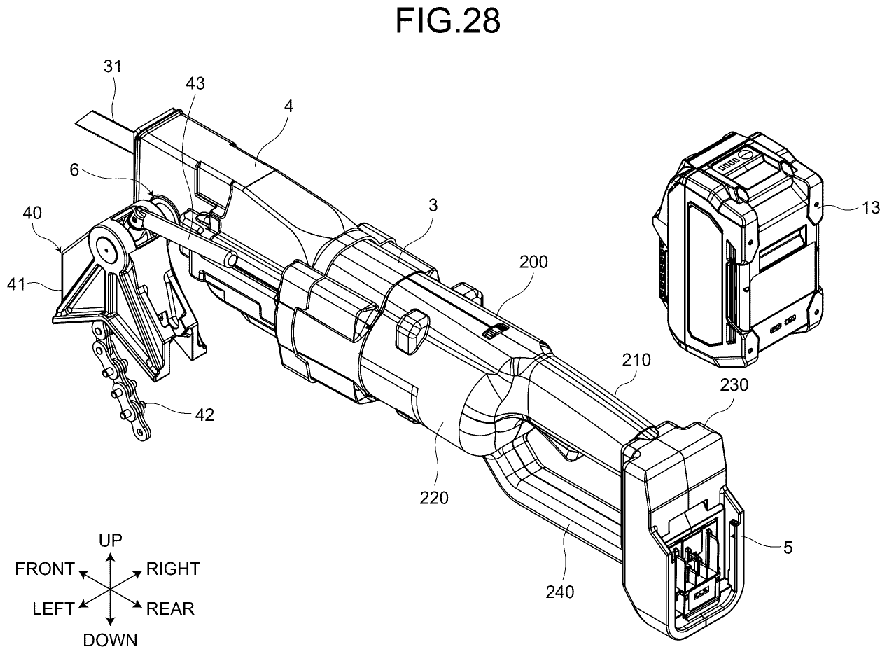

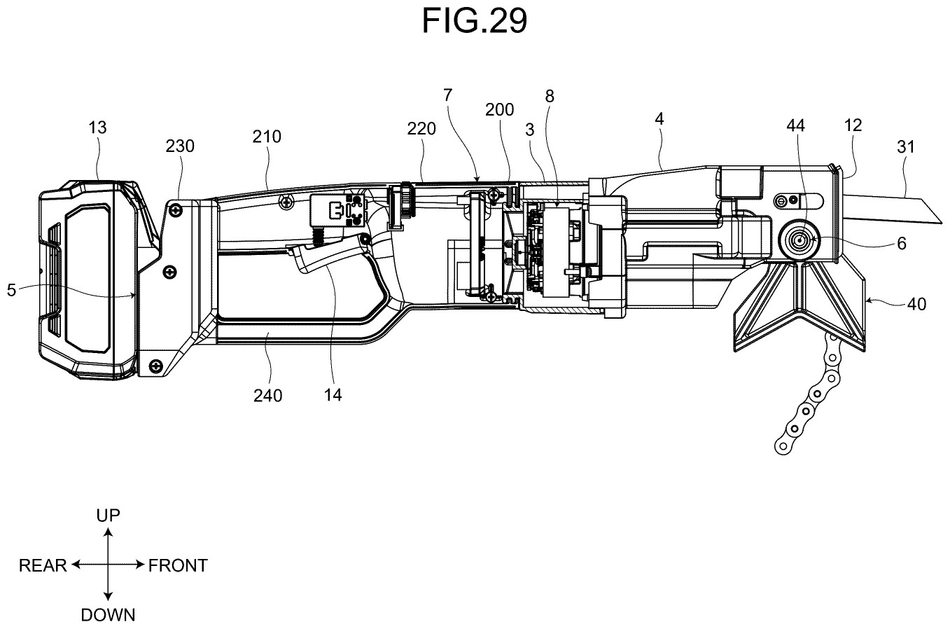

FIG. 24 is a front perspective view illustrating a reciprocating saw 1B according to the present embodiment. FIG. 25 is a rear perspective view illustrating the reciprocating saw 1B of the embodiment. FIG. 26 is a diagram of the reciprocating saw 1B of the embodiment as viewed from above. FIG. 27 is a diagram of the reciprocating saw 1B of the present embodiment as viewed from the right side. FIG. 28 is an exploded view illustrating the reciprocating saw 1B of the embodiment. FIG. 29 is a diagram illustrating the inside of the reciprocating saw 1B of the embodiment.

The reciprocating saw 1B includes a rear housing 200, the middle housing 3, the front housing 4, the battery mounting portion 5, the vise mounting portion 6, the controller 7, the motor 8, the fan 9, the reciprocation conversion mechanism 10, the slider 11, and the guide shoe 12.

The rear housing 200 includes a grip portion 210, a controller housing portion 220, a battery holding portion 230, and a connecting portion 240. The grip portion 210 is gripped by an operator. The trigger lever 14 is disposed on the grip portion 210. The controller housing portion 220 houses the controller 7. The battery holding portion 230 holds the battery pack 13 via the battery mounting portion 5. The connecting portion 240 is disposed downward of the grip portion 210. The connecting portion 240 is disposed so as to connect the controller housing portion 220 and the battery holding portion 230. The grip portion 210 is also disposed so as to connect the controller housing portion 220 and the battery holding portion 230. Each of the grip portion 210 and the connecting portion 240 has a rod shape elongated in the front-rear direction. The controller housing portion 220 is disposed on the front side of the grip portion 210 and the connecting portion 240. The battery holding portion 230 is disposed on the rear side of the grip portion 210 and the connecting portion 240. In the embodiment, the rear housing 200 includes a loop-shaped handle portion.

The middle housing 3 is disposed on the front side of the rear housing 200. The front housing 4 is disposed on the front side of the middle housing 3.

The battery mounting portion 5 is disposed at a rear portion of the battery holding portion 230. The battery pack 13 is mounted to the battery mounting portion 5. In the present embodiment, the battery pack 13 is mounted to the battery mounting portion 5 by being inserted to the battery mounting portion 5 from the upper side toward the lower side of the battery mounting portion 5. The battery pack 13 is removed from the battery mounting portion 5 by being removed upward from the battery mounting portion 5.

In the present embodiment, the motor 8 is disposed forward of the grip portion 210. The battery mounting portion 5 is disposed rearward of the motor 8. The battery mounting portion 5 is disposed rearward of the grip portion 210. The battery mounting portion 5 is disposed in the battery holding portion 230 provided at the rear end portion of the grip portion 210. The controller 7 is disposed forward of the grip portion 210. The controller 7 has a plate shape. The controller 7 is disposed such that a surface of the controller 7 is orthogonal to the rotation axis AX.

As described above, in the present embodiment, the motor 8 is disposed forward of the grip portion 210, and the battery mounting portion 5 is disposed rearward of the grip portion 210.

In the above structure, since the battery pack 13 as a heavy object is disposed rearward of the grip portion 210, the weight balance of the reciprocating saw 1A is improved. In addition, since the connecting portion 240 is provided, the strength of the rear housing 200 is improved. The rear housing 200 can receive the weight of the battery pack 13 by both the grip portion 210 and the connecting portion 240.

In the present embodiment, the battery mounting portion 5 is disposed at a rear end portion of the grip portion 21.

In the above structure, the weight balance of the reciprocating saw 1A is improved.

In the present embodiment, the battery pack 13 is mounted to the battery mounting portion 5 by being inserted from an upper side toward a lower side of the battery mounting portion 5.

In the above structure, the operator can smoothly attach and detach the battery pack 13 to and from the battery mounting portion 5.

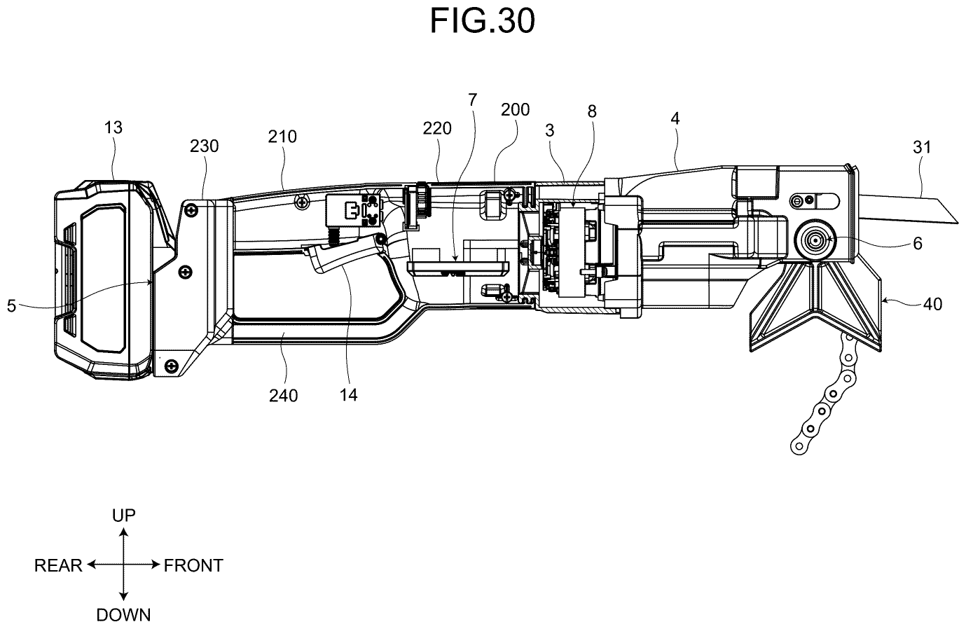

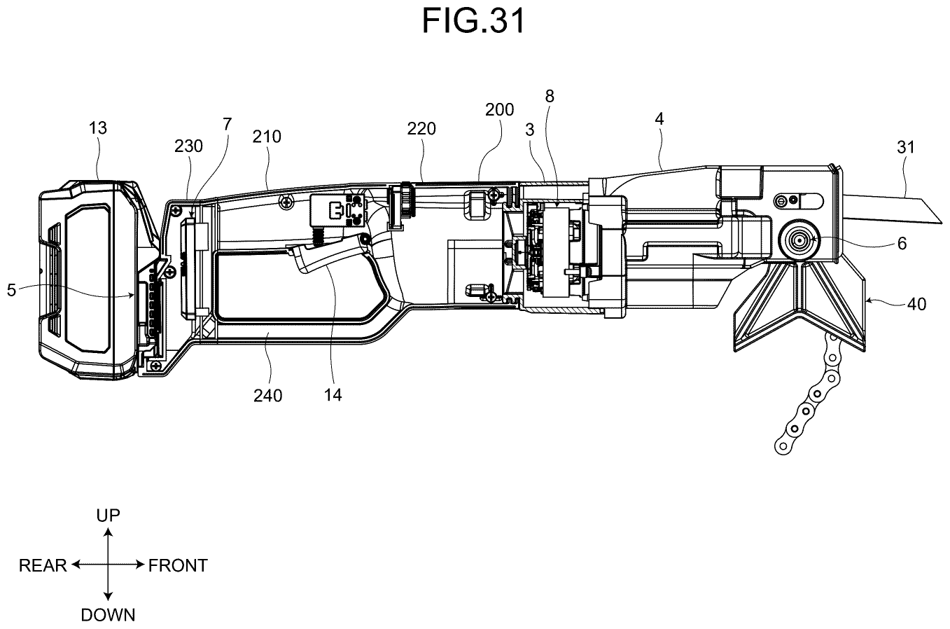

Hereinafter, modifications of the present embodiment will be described. Each of FIGS. 30 and 31 is a diagram illustrating the inside of a reciprocating saw 1B according to a modification of the embodiment. As illustrated in FIG. 30, the controller 7 may be disposed such that a surface of the controller 7 is parallel to the rotation axis AX.

As illustrated in FIG. 31, the motor 8 may be disposed forward of a grip portion 210, and the controller 7 may be disposed rearward of the grip portion 210. In the example illustrated in FIG. 31, the controller 7 is housed in a battery holding portion 230 provided at a rear end portion of the grip portion 210. In the example illustrated in FIG. 31, the controller 7 is disposed such that a surface of the controller 7 is orthogonal to the rotation axis AX.

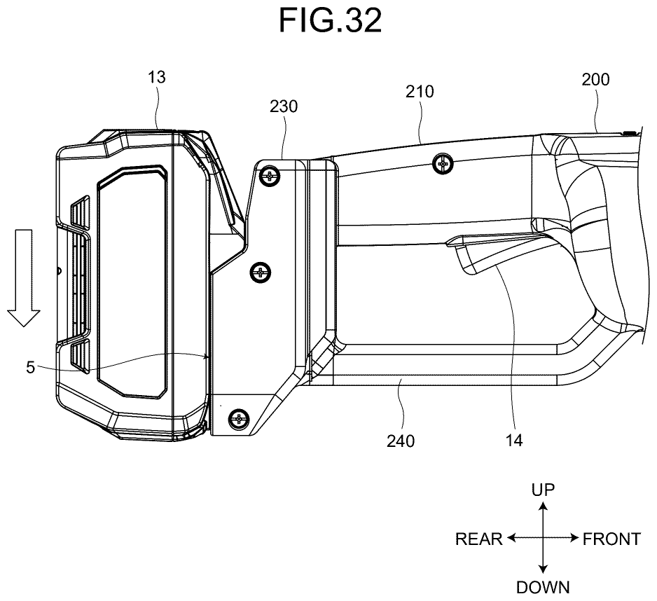

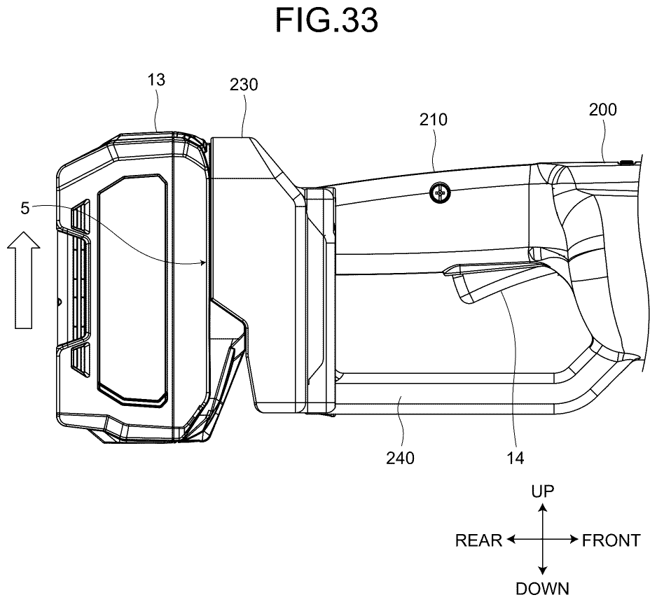

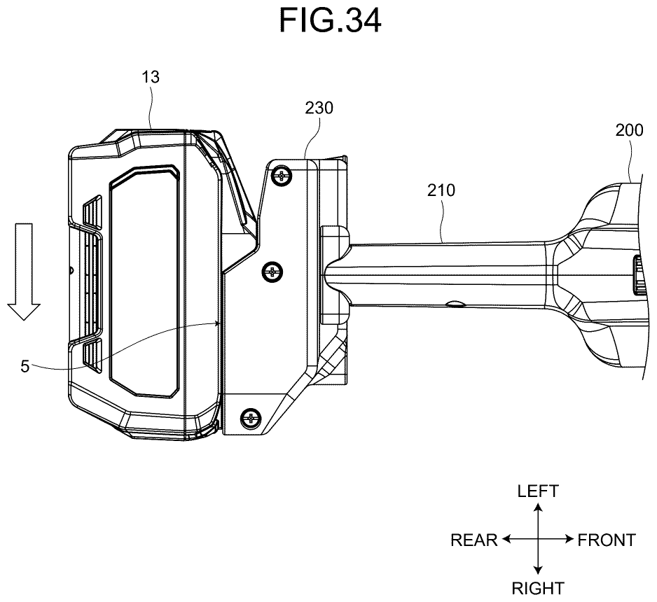

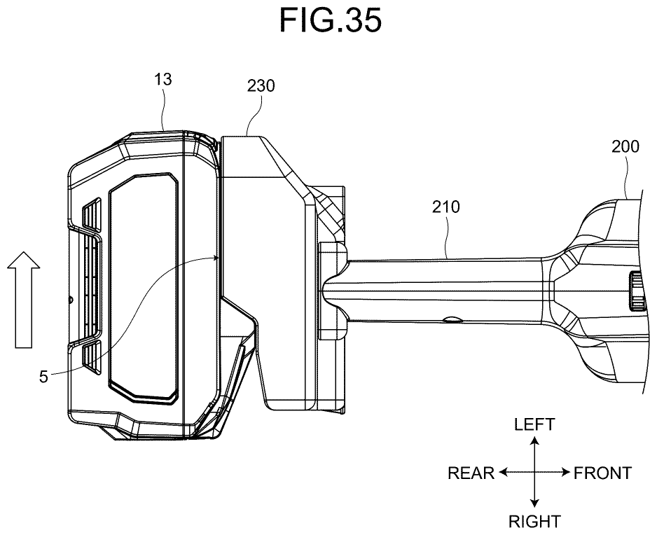

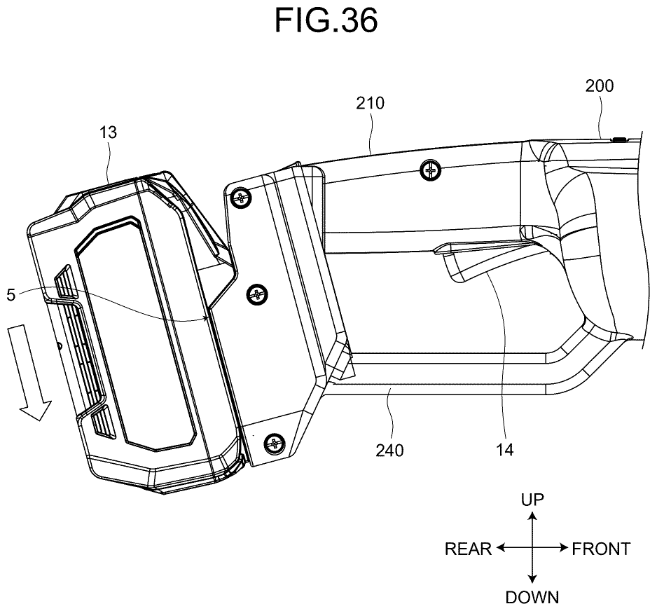

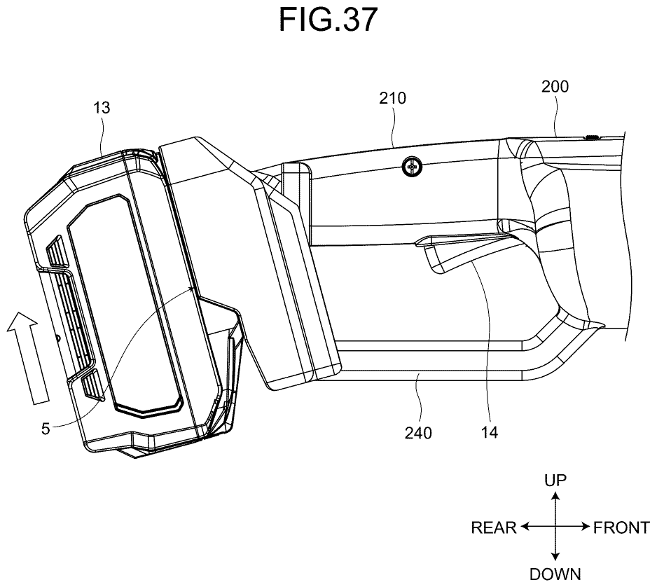

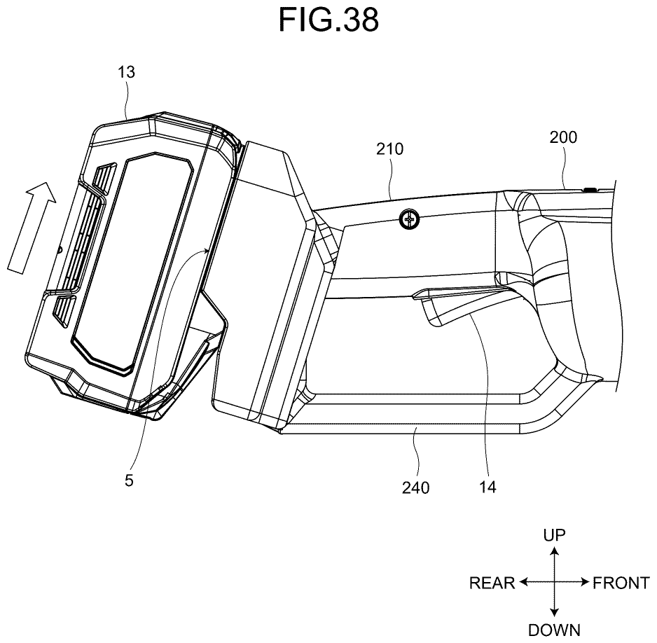

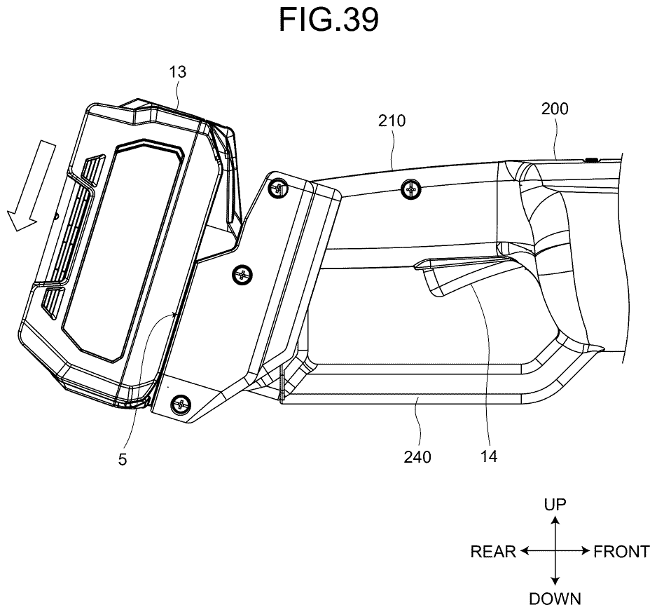

Each of FIGS. 32 to 39 is a diagram for describing a modification of the mounting method of the battery pack 13 of the second embodiment. Each of FIGS. 32 to 39 illustrates an example in which the battery mounting portion 5 is disposed on the rear side of the grip portion 210. As illustrated in FIG. 32, the battery pack 13 may be mounted to the battery mounting portion 5 by being inserted from the upper side toward the lower side of the battery mounting portion 5. As illustrated in FIG. 33, the battery pack 13 may be mounted to the battery mounting portion 5 by being inserted from the lower side toward the upper side of the battery mounting portion 5. As illustrated in FIG. 34, the battery pack 13 may be mounted to the battery mounting portion 5 by being inserted from the left side toward the right side of the battery mounting portion 5. As illustrated in FIG. 35, the battery pack 13 may be mounted to the battery mounting portion 5 by being inserted from the right side toward the left side of the battery mounting portion 5. As illustrated in FIG. 36, the battery pack 13 may be mounted to the battery mounting portion 5 by being inserted from the upper side toward the lower side of the battery mounting portion 5 in a direction inclined forward. As illustrated in FIG. 37, the battery pack 13 may be mounted to the battery mounting portion 5 by being inserted from the lower side toward the upper side of the battery mounting portion 5 in a direction inclined rearward. As illustrated in FIG. 38, the battery pack 13 may be mounted to the battery mounting portion 5 by being inserted from the lower side toward the upper side of the battery mounting portion 5 in a direction inclined forward. As illustrated in FIG. 39, the battery pack 13 may be mounted to the battery mounting portion 5 by being inserted from the upper side toward the lower side of the battery mounting portion 5 in a direction inclined rearward.

### Third Embodiment

A third embodiment will be described. In the following description, the same or equivalent components as those of the above-described embodiment are denoted by the same reference numerals, and description of the components is simplified or omitted.

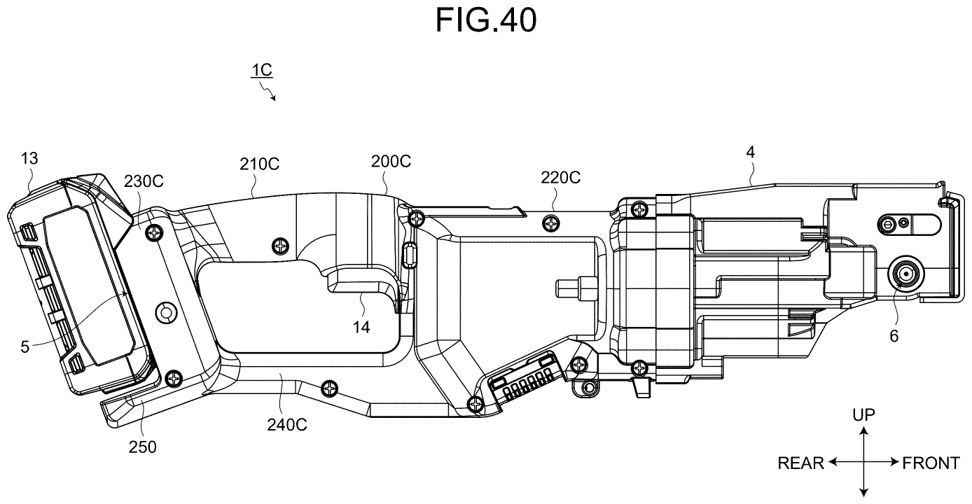

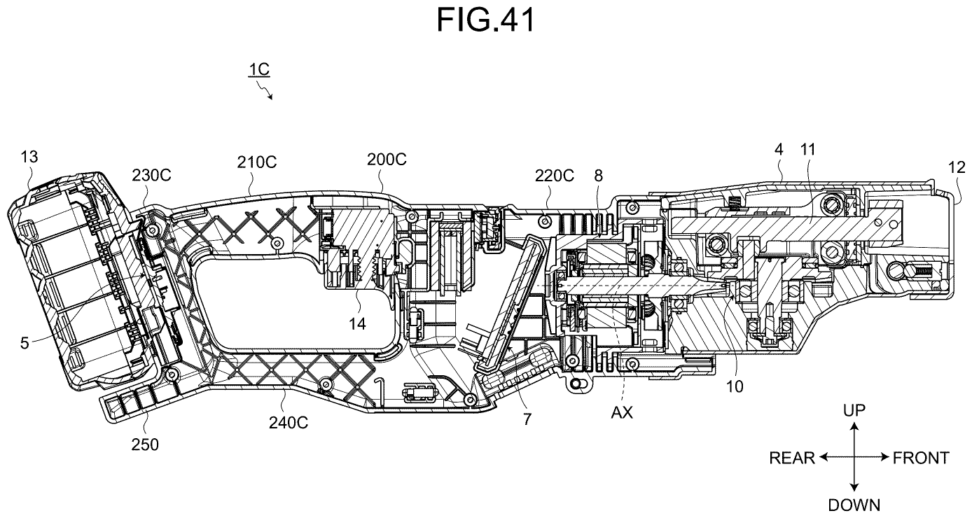

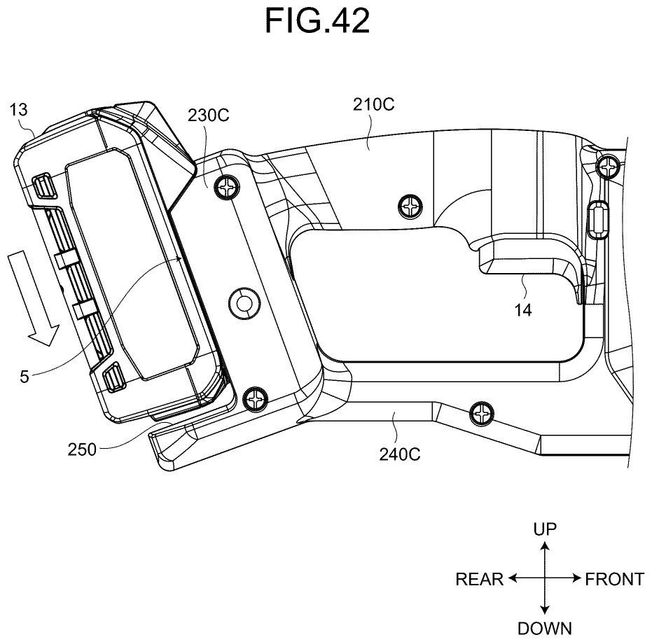

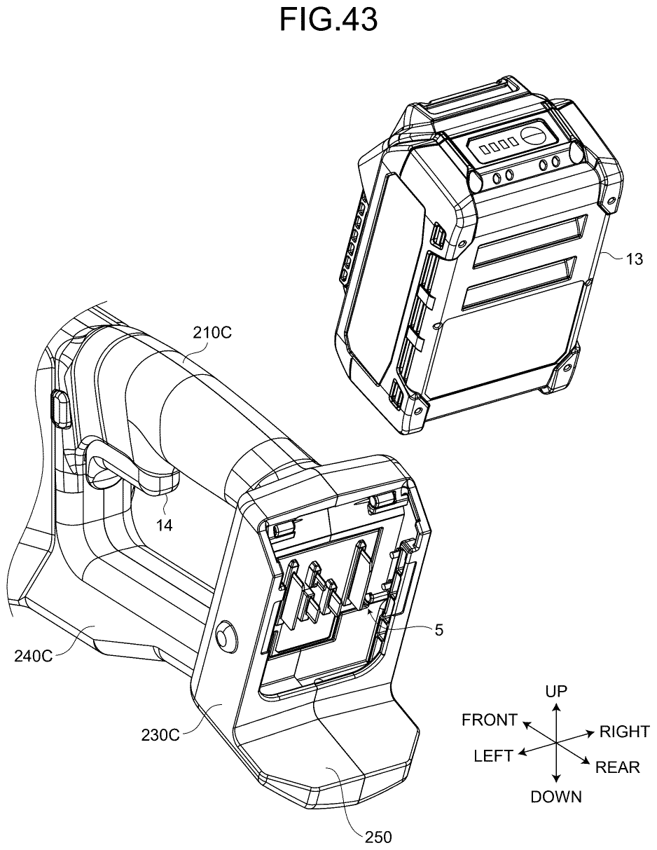

FIG. 40 is a diagram of a reciprocating saw 1C of the present embodiment as viewed from the right side. FIG. 41 is a cross-sectional view illustrating the reciprocating saw 1C of the embodiment. FIG. 42 is a diagram of a rear portion of the reciprocating saw 1C of the embodiment as viewed from the right side. FIG. 43 is an exploded perspective view illustrating the rear portion of the reciprocating saw 1C of the embodiment as viewed from the rear side.

The reciprocating saw 1C includes a rear housing 200C, the front housing 4, the battery mounting portion 5, the vise mounting portion 6, the controller 7, the motor 8, the reciprocation conversion mechanism 10, the slider 11, and the guide shoe 12.

The rear housing 200C includes a grip portion 210C, a housing portion 220C, a battery holding portion 230C, and a connecting portion 240C. The grip portion 210C is gripped by an operator. The trigger lever 14 is disposed on the grip portion 210C. The housing portion 220C houses the controller 7 and the motor 8. The motor 8 is disposed forward of the controller 7. The battery holding portion 230C holds the battery pack 13 via the battery mounting portion 5. The battery mounting portion 5 is disposed at a rear portion of the battery holding portion 230C. The connecting portion 240C is disposed downward of the grip portion 210C. The connecting portion 240C is disposed so as to connect 220C and the battery holding portion 230C. The grip portion 210C is also disposed so as to connect the housing portion 220C and the battery holding portion 230C. Each of the grip portion 210C and the connecting portion 240C has a rod shape elongated in the front-rear direction. The housing portion 220C is disposed forward of the grip portion 210C and the connecting portion 240C. The battery holding portion 230C is disposed rearward of the grip portion 210C and the connecting portion 240C. The battery holding portion 230C is disposed so as to connect the rear end of the grip portion 210C and the rear end of the connecting portion 240C. The rear housing 200C includes a loop-shaped handle portion.

The battery mounting portion 5 is disposed at a rear portion of the battery holding portion 230C. A battery pack 13 is mounted to the battery mounting portion 5. In the present embodiment, the battery pack 13 is mounted to the battery mounting portion 5 by being inserted to the battery mounting portion 5 from the upper side toward the lower side of the battery mounting portion 5 in a direction inclined forward. The battery pack 13 is removed from the battery mounting portion 5 by being removed upward from the battery mounting portion 5 in a direction inclined rearward.

In the present embodiment, the battery holding portion 230C includes a guard portion 250 facing the lower surface of the battery pack 13 mounted to the battery mounting portion 5. The guard portion 250 protrudes rearward from a lower portion of the battery holding portion 230C. The lower surface of the battery pack 13 mounted to the battery mounting portion 5 and the upper surface of the guard portion 250 face each other with a gap therebetween.

In the present embodiment, the motor 8 is disposed forward of the grip portion 210C. The battery mounting portion 5 is disposed rearward of the motor 8. The battery mounting portion 5 is disposed rearward of the grip portion 210C. The battery mounting portion 5 is disposed in the battery holding portion 230C provided at the rear end portion of the grip portion 210C. The controller 7 is disposed forward of the grip portion 210C. The controller 7 has a plate shape. The controller 7 is disposed such that a surface of the controller 7 is inclined with respect to the rotation axis AX.

As described above, in the present embodiment, the motor 8 is disposed forward of the grip portion 210C, and the battery mounting portion 5 is disposed rearward of the grip portion 210C.

In the above structure, since the battery pack 13 as a heavy object is disposed rearward of the grip portion 210C, the weight balance of the reciprocating saw 1C is improved. In addition, since the connecting portion 240C is provided, the strength of the rear housing 200 is improved. The rear housing 200 can receive the weight of the battery pack 13 by both the grip portion 210C and the connecting portion 240C.

In the present embodiment, the battery mounting portion 5 is disposed at a rear end portion of the grip portion 210C.

In the above structure, the weight balance of the reciprocating saw 1C is improved.

In the present embodiment, the battery pack 13 is mounted to the battery mounting portion 5 by being inserted from the upper side toward the lower side of the battery mounting portion 5 in a direction inclined forward.

In the above structure, the operator can smoothly attach and detach the battery pack 13 to and from the battery mounting portion 5. In addition, since the battery pack 13 is disposed obliquely, it is possible to prevent an increase in the dimension in the front-rear direction and the dimension in the up-down direction of the reciprocating saw 1C.

In the present embodiment, the battery holding portion 230C includes the guard portion 250 facing the lower surface of the battery pack 13.

In the above structure, an operator can perform work in a state where the guard portion 250 is supported by a hand from below.

### Fourth Embodiment

A fourth embodiment will be described. In the following description, the same or equivalent components as those of the above-described embodiment are denoted by the same reference numerals, and description of the components is simplified or omitted.

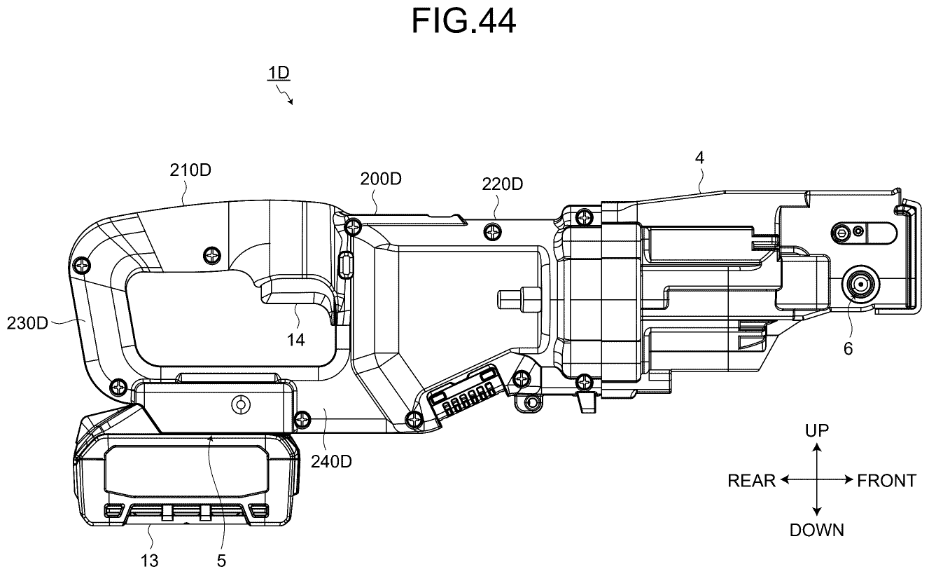

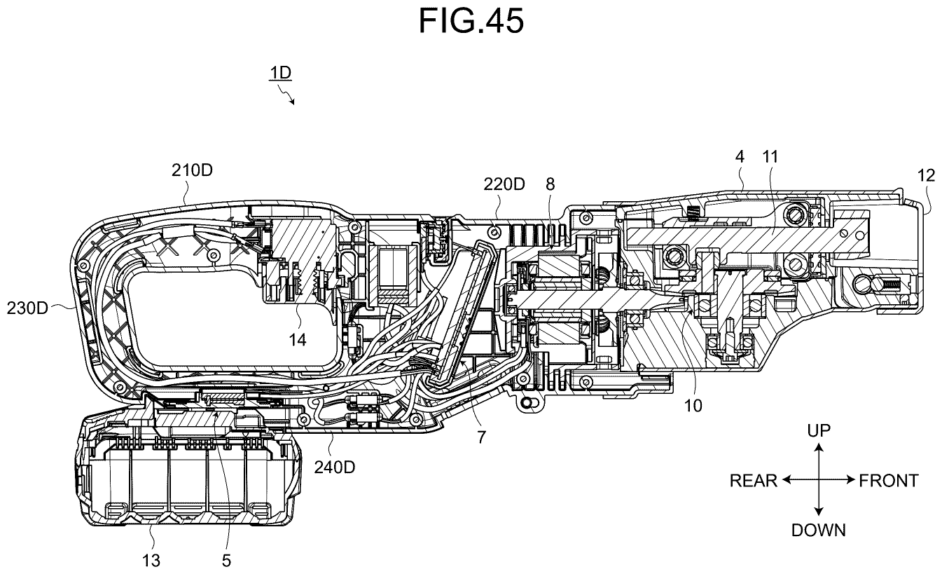

FIG. 44 is a diagram of a reciprocating saw 1D of the present embodiment as viewed from the right side. FIG. 45 is a cross-sectional view illustrating the reciprocating saw 1D of the embodiment.

The reciprocating saw 1D includes a rear housing 200D, the front housing 4, the battery mounting portion 5, the vise mounting portion 6, the controller 7, the motor 8, the reciprocation conversion mechanism 10, the slider 11, and the guide shoe 12.

The rear housing 200D includes a grip portion 210D, a housing portion 220D, a first connecting portion 240D, and a second connecting portion 230D. The grip portion 210D is gripped by an operator. The trigger lever 14 is disposed on the grip portion 210D. The housing portion 220D houses the controller 7 and the motor 8. The motor 8 is disposed forward of the controller 7. The first connecting portion 240D is disposed downward of the grip portion 210D. The first connecting portion 240D is disposed so as to connect the housing portion 220D and the second connecting portion 230D. The grip portion 210D is also disposed so as to connect the housing portion 220D and the second connecting portion 230D. Each of the grip portion 210D and the first connecting portion 240D has a rod shape elongated in the front-rear direction. The housing portion 220D is disposed forward of the grip portion 210D and the first connecting portion 240D. The second connecting portion 230D is disposed rearward of the grip portion 210D and the first connecting portion 240D. The second connecting portion 230D is disposed so as to connect the rear end of the grip portion 210D and the rear end of the first connecting portion 240D. The rear housing 200D includes a loop-shaped handle portion.

In the present embodiment, the first connecting portion 240D holds the battery pack 13 via the battery mounting portion 5. The battery mounting portion 5 is disposed at a rear portion or a lower portion of the first connecting portion 240D. A battery pack 13 is mounted to the battery mounting portion 5. In the present embodiment, the battery pack 13 is mounted to the battery mounting portion 5 by being inserted to the battery mounting portion 5 from the rear side toward the front side of the battery mounting portion 5. The battery pack 13 is removed from the battery mounting portion 5 by being removed rearward from the battery mounting portion 5.

Note that, in the present embodiment, the battery pack 13 may be mounted to the battery mounting portion 5 by being inserted to the battery mounting portion 5 from the front side toward the rear side of the battery mounting portion 5. In this case, the battery pack 13 is removed from the battery mounting portion 5 by being removed forward from the battery mounting portion 5.

Note that, in the present embodiment, the battery pack 13 may be mounted to the battery mounting portion 5 by being inserted to the battery mounting portion 5 from the left side toward the right side of the battery mounting portion 5. In this case, the battery pack 13 is removed from the battery mounting portion 5 by being removed leftward from the battery mounting portion 5.

Note that, in the present embodiment, the battery pack 13 may be mounted to the battery mounting portion 5 by being inserted to the battery mounting portion 5 from the right side toward the left side of the battery mounting portion 5. In this case, the battery pack 13 is removed from the battery mounting portion 5 by being removed rightward from the battery mounting portion 5.

### Fifth Embodiment

A fifth embodiment will be described. In the following description, the same or equivalent components as those of the above-described embodiment are denoted by the same reference numerals, and description of the components is simplified or omitted.

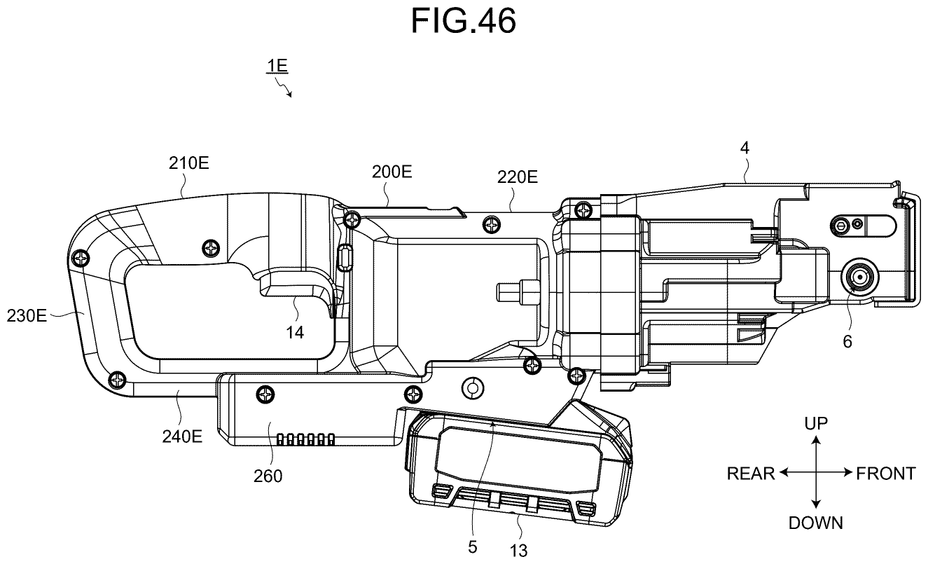

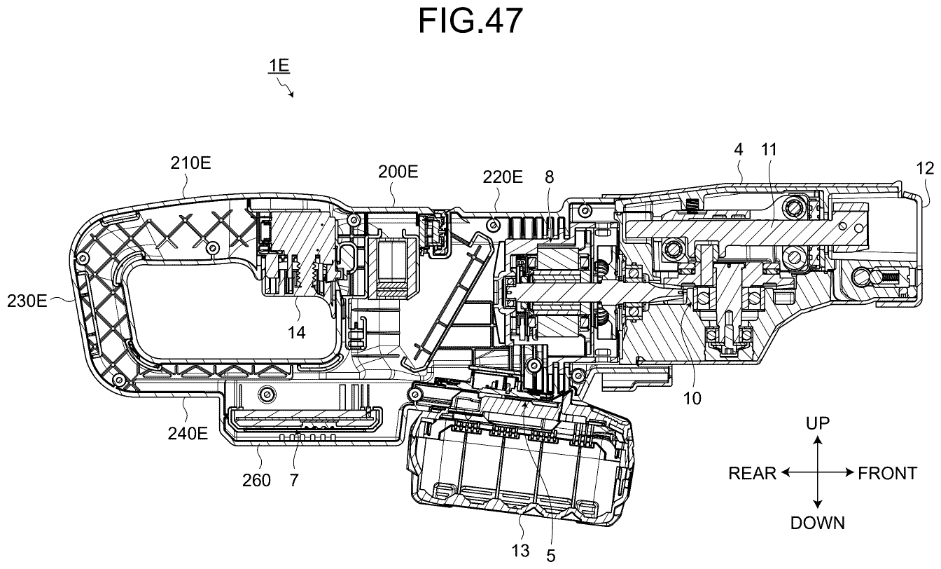

FIG. 46 is a diagram of a reciprocating saw 1E of the present embodiment as viewed from the right side. FIG. 47 is a cross-sectional view illustrating the reciprocating saw 1E of the embodiment.

The reciprocating saw 1E includes a rear housing 200E, the front housing 4, the battery mounting portion 5, the vise mounting portion 6, the controller 7, the motor 8, the reciprocation conversion mechanism 10, the slider 11, and the guide shoe 12.

The rear housing 200E includes a grip portion 210E, a motor housing portion 220E, a first connecting portion 240E, a second connecting portion 230E, and a controller housing portion 260. The grip portion 210E is gripped by an operator. The trigger lever 14 is disposed on the grip portion 210E. The motor housing portion 220E houses the motor 8. The first connecting portion 240E is disposed downward of the grip portion 210E. The first connecting portion 240E is disposed so as to connect the motor housing portion 220E and the second connecting portion 230E. The grip portion 210E is also disposed so as to connect the motor housing portion 220E and the second connecting portion 230E. Each of the grip portion 210E and the first connecting portion 240E has a rod shape elongated in the front-rear direction. The motor housing portion 220E is disposed forward of the grip portion 210E and the first connecting portion 240E. The second connecting portion 230E is disposed rearward of the grip portion 210E and the first connecting portion 240E. The second connecting portion 230E is disposed so as to connect the rear end of the grip portion 210E and the rear end of the first connecting portion 240E. The rear housing 200E includes a loop-shaped handle portion. The controller housing portion 260 houses the controller 7. The controller housing portion 260 is provided at a front portion or a lower portion of the first connecting portion 240E.

In the present embodiment, the motor housing portion 220E holds the battery pack 13 via the battery mounting portion 5. The battery mounting portion 5 is disposed at a lower portion of the motor housing portion 220E. A battery pack 13 is mounted to the battery mounting portion 5. In the present embodiment, the battery pack 13 is mounted to the battery mounting portion 5 by being inserted to the battery mounting portion 5 from the front side toward the rear side of the battery mounting portion 5. The battery pack 13 is removed from the battery mounting portion 5 by being removed forward from the battery mounting portion 5.

Note that, in the present embodiment, the battery pack 13 may be mounted to the battery mounting portion 5 by being inserted to the battery mounting portion 5 from the rear side toward the front side of the battery mounting portion 5. In this case, the battery pack 13 is removed from the battery mounting portion 5 by being removed rearward from the battery mounting portion 5.

Note that, in the present embodiment, the battery pack 13 may be mounted to the battery mounting portion 5 by being inserted to the battery mounting portion 5 from the left side toward the right side of the battery mounting portion 5. In this case, the battery pack 13 is removed from the battery mounting portion 5 by being removed leftward from the battery mounting portion 5.

Note that, in the present embodiment, the battery pack 13 may be mounted to the battery mounting portion 5 by being inserted to the battery mounting portion 5 from the right side toward the left side of the battery mounting portion 5. In this case, the battery pack 13 is removed from the battery mounting portion 5 by being removed rightward from the battery mounting portion 5.

### EXPLANATION OF THE REFERENCE NUMBERS

1A RECIPROCATING SAW
1B RECIPROCATING SAW
1C RECIPROCATING SAW
1D RECIPROCATING SAW
1E Reciprocating saw
2 Rear housing
2L Left housing
2R Right housing
2S Screw
3 Middle housing
4 Front housing
5 Battery mounting portion
6 Vise mounting portion
7 Controller
8 Motor
9 Fan
10 Reciprocation conversion mechanism
11 Slider
11A Slider block
11B Holder portion
12 Guide shoe
13 Batter pack
14 Trigger lever
15 Stator
15A Stator core
15B Rear insulator
15C Front insulator
15D Coil
16 Rotor
16A Rotor core
16B Permanent magnet
16C Rotor shaft
17 Sensor substrate
18 Motor case
19 Gear case
19C Cover
20 Rotor bearing
21 Grip portion
22 Controller housing portion
24 Pinion gear
25 Bevel gear
26 Support shaft
27 Eccentric pin
28 Bearing
29 Bearing
30 Blade holder
31 Blade
32 Controller housing portion
40 Vise
41 Fixing member
42 Winding member
43 Fastener
44 Mounting member
90 Slider guide
91 Slider guide
200 Rear housing
200C Rear housing
200D Rear housing
200E Rear housing
210 Grip portion
210C Grip portion
210D Grip portion
210E Grip potion
220 Controller housing portion
220C Housing portion
220D Housing portion
220E Motor housing portion
230 Battery holding portion
230C Battery holding portion
230D Second connecting portion
230E Second connecting portion
240 Connecting portion
240C Connecting portion
240D First connecting portion
240E First connecting portion
250 Guard portion
260 Controller housing portion
AX Rotation axis

1. A reciprocating saw comprising:
a motor;
a reciprocation conversion mechanism, which is disposed forward of the motor and reciprocates a blade based on a rotational force of the motor;
a battery mounting portion to which a battery pack is mounted; and
a vise mounting portion, which is dispose forward of the motor and to which a vise is mounted.

2. The reciprocating saw according to claim 1, comprising
a grip portion,
wherein the motor and the battery mounting portion are each disposed forward of the grip portion.

3. The reciprocating saw according to claim 2,
wherein the battery mounting portion is disposed rearward of the motor.

4. The reciprocating saw according to claim 2,
wherein the battery mounting portion is disposed downward of the motor.

5. The reciprocating saw according to claim 2,
wherein the vise is mounted to the vise mounting portion by being inserted from one side toward other side of the vise mounting portion in a left-right direction, and
the battery pack is mounted to the battery mounting portion by being inserted from one side toward other side of the battery mounting portion in the left-right direction.

6. The reciprocating saw according to claim 1, comprising
a grip portion,
wherein the motor is disposed forward of the grip portion, and
the battery mounting portion is disposed rearward of the grip portion.

7. The reciprocating saw according to claim 6,
wherein the battery mounting portion is disposed at a rear end portion of the grip portion.

8. The reciprocating saw according to claim 6,
wherein the battery pack is mounted to the battery mounting portion by being inserted from one side toward other side of the battery mounting portion.

9. The reciprocating saw according to claim 8,
wherein the battery pack is mounted to the battery mounting portion by being inserted from an upper side toward a lower side of the battery mounting portion.

10. The reciprocating saw according to claim 1, comprising
a controller that controls the motor,
wherein the controller is disposed rearward of the motor.

11. The reciprocating saw according to claim 10, comprising
a grip portion,
wherein the motor, the battery mounting portion, and the controller are each disposed forward of the grip portion.

12. The reciprocating saw according to claim 10, comprising
a grip portion,
wherein the motor and the battery mounting portion are each disposed forward of the grip portion, and
the controller is disposed rearward of the grip portion.

13. The reciprocating saw according to claim 10, comprising
a grip portion,
wherein the motor and the controller are each disposed forward of the grip portion, and
the battery mounting portion is disposed rearward of the grip portion.

14. The reciprocating saw according to claim 10, comprising
a grip portion,
wherein the motor is disposed forward of the grip portion, and
the battery mounting portion and the controller are each disposed on rearward of the grip portion.

15. The reciprocating saw according to claim 7,
wherein the battery pack is mounted to the battery mounting portion by being inserted from an upper side toward a lower side of the battery mounting portion in a direction inclined forward.

16. The reciprocating saw according to claim 15, comprising:
a connecting portion disposed downward of the grip portion; and
a battery holding portion, which is disposed on a rear side of the grip portion and the connecting portion and is disposed so as to connect a rear end portion of the grip portion and a rear end portion of the connecting portion,
wherein the battery mounting portion is disposed at a rear portion of the battery holding portion.

17. The reciprocating saw according to claim 16,
wherein the battery holding portion has a guard portion facing a lower surface of a battery pack.

18. The reciprocating saw according to claim 4, comprising:
a first connecting portion disposed downward of the grip portion; and
a second connecting portion, which is disposed on a rear side of the grip portion and the first connecting portion and is disposed so as to connect a rear end portion of the grip portion and a rear end portion of the first connecting portion,
wherein the battery mounting portion is disposed at a rear portion or a lower portion of the first connecting portion.

19. The reciprocating saw according to claim 2, comprising
a motor housing portion, which is disposed forward of the grip portion and houses the motor,
wherein the battery mounting portion is disposed at a lower portion of the motor housing portion.
